(19) United States
(12) Patent Application Publication
(10) Pub. No.: US 2011/0303874 A1
(43) Pub. Date: Dec. 15, 2011

(54) METHOD AND APPARATUS FOR THE PRODUCTION OF CHLOROSILANES

(76) Inventors: Peter Dold, Halle/Saale (DE); Athanasios Tom Balkos, Waterloo (CA); Jeffrey Dawkins, Kitchener (CA)

(21) Appl. No.: 13/160,803

(22) Filed: Jun. 15, 2011

Related U.S. Application Data
(63) Continuation of application No. PCT/CA2009/001905, filed on Dec. 23, 2009.
Application No. PCT/CA2009/001905 is a continuation-in-part of application No. PCT/US2008/013996, filed on Dec. 23, 2008.

(51) Int. Cl. C01B 33/021; B01J 19/00

(52) U.S. Cl. 252/372; 422/129

(57) ABSTRACT

A method and respect material for the production of chlorosilanes (primarily: trichlorosilane) and the deposition of high purity poly-silicon from these chlorosilanes. The source for the chlorosilane production consists of eutectic or hypo-eutectic copper-silicon, the concentration range of said copper-silicon is between 10 and 16 wt % silicon. The eutectic or hypo-eutectic copper-silicon is cast in a shape suitable for a chlorination reactor, where it is exposed to a process gas, which consists, at least partially, of HCl. The gas reacts at the surface of the eutectic or hypo-eutectic copper-silicon and extracts silicon in the form of volatile chlorosilane. The depleted eutectic or hypoeutectic material might be afterwards recycled in such a way that the amount of extracted silicon is replenished and the material is re-cast into the material shape desired.

(This application is a Continuation of PCT/CA2009/001905, Filed Dec. 23, 2009 and is a Continuation-In-Part of PCT Application No. PCT/US2008/013996, Filed Dec. 23, 2008 both of which are herein incorporated by reference.)

### FIELD OF THE INVENTION

The invention relates to a method and apparatus for the production of chlorosilanes.

### BACKGROUND OF THE INVENTION

Generally for the production of chlorosilanes from silicon, HCl or a mixture of HCl and hydrogen is reacted with silicon in a fixed bed reactor, a fluidized bed reactor, or any kind of stirred bed reactor. The process is generally carried out at temperatures between 300° C. and 1100° C. In most cases metallurgical grade silicon (i.e. silicon with a purity of 98 to 99.5%) is used for the reaction, the products are either used directly in subsequent chemical reactions or after a further refinement step. The latter applies for the use of chlorosilanes for the production of high purity silicon in Siemens type CVD reactors. Certain additives might be mixed to the metallurgical grade silicon in order to improve the productivity or the selectivity of the reaction as it is described in U.S. Pat. No. 4,676,967 (Breneman) for copper or in U.S. Patent Application Publication No. 2007/0086936 A1 (Hoel et al.) for chromium. Providing a large contact area between silicon and the used additives, is in most cases a challenge and requires the use of crushed, small sized silicon particles as described in U.S. Pat. No. 6,057,469 (Margaria et al.) and U.S. Application Publication No. 2004/0022713A1 (Bulan et al.) .

With respect to the use of the produced chlorosilanes, minimization of gaseous impurities will reduce the cost for cleaning and filtering of the gases. Copper is known to act not only as a catalyst for improving the productivity of chlorosilane generation but, in addition, in acting as a getter material for metallic impurities. Olson described the placement of the copper-silicide in direct vicinity to a heated graphite filament. Movement of the gas was driven only due to natural convection caused by the temperature difference between the hot filament and the relative cold walls of the chamber. Generally single chamber arrangements can cause several problems. For example, in the method described in U.S. Pat. No. 4,481,232 only a limited amount of copper-silicide can be charged into the chamber and the alloy is heated indirectly by the filament due to its proximity to the filament. The alloy temperature can not therefore be suitably controlled and will increase beyond the optimal temperature range for gaseous silicon production. One skilled in the art will recognize that a too high temperature will mobilize the metallic impurities captured in the copper-silicon alloy or the copper itself, which will result in an elevated level of metallic impurities in the refined silicon. It will be further recognized that, especially in the presence of hydrogen, too high reaction temperatures will unfavourably alter the composition of the gaseous chlorosilane product stream and will mobilize metallic impurities captured in the copper-silicon alloy or the copper itself, thus lowering the productivity or the quality of the refinement process. The single chamber set-up also has a lack of adequate suppression of volatile impurities and particles which will affect the purity of the deposited silicon. It is well known in silicon industry that even trace amounts of copper can be highly unfavourable for the use of silicon in semiconductor or solar applications. The single chamber arrangement disclosed in U.S. Pat. No. 4,481,232 is therefore only suitable for laboratory size applications and would not be optimal for scale-up. Further the production of chlorosilanes is integral to the method of depositing purified silicon on a hot filament.

High purity silicon is required for any application in electronic industry, such as the use of solar cells or manufacturing of semiconducting devices. The necessary purity levels for any electronic application are significantly higher than what is provided by so-called metallurgical grade silicon (m.g.-silicon). Therefore, complicated and expensive refinement steps are required. This results in a strong need for more cost-efficient and energy efficient processes, in order to purify m.g.-silicon in a simplified way.

In general, two approaches for the refinement of silicon are distinguished, the chemical path and the metallurgical path. In case of the chemical refinement, the m.g.-silicon is transferred into the gas phase in form of a chlorosilane and is later on deposited in form of a Chemical Vapor Deposition (CVD) process (use of trichlorosilane, e.g. conventional Siemens process, see e.g. U.S. Pat. Nos. 2,999,735; 3,011,877; 3,979,490; and 6,221,155, or use of silane, see e.g. U.S. Pat. Nos. 4,444,811 or 4,676,967). In this case, the first step is the formation of chlorosilanes from small size (grained/crashed) silicon particles in a Fluidized Bed Reactor, and the consequent distillation of the gaseous species. Since the silicon is used in form of small particles, which are fully exposed to the process gas, impurities (metallic impurities, boron, phosphorous etc.) can also go into the gas phase and therefore have to be removed by distillation before the chlorosilanes can be used for silicon deposition, or for further chemical treatment like hydrogenization for the production of silane.

The metallurgical approach involves the casting of m.g.-silicon, either just as silicon (and removal of impurities by segregation and oxidation, as disclosed e.g. in WO/2008/031,229 A1) or as an alloy of m.g.-silicon with a metal (e.g. aluminum). In the latter case, the metal acts as a catcher/getter for impurities, but it has to be leached out wet-chemically, before the refined silicon is cast into ingots. The metallurgical approach can also result in significantly lower purity levels than the chemical path.

A major disadvantage of the chemical path is the fact, that during the chlorosilane formation, small size particles of the m.g. silicon stock are required in order to provide a large silicon surface for reaction. Further, undesirable high pressures and/or high temperatures are required to keep the reaction between m.g.-silicon and the process gas (HCl, or HCl, H2 mixture) going. This can result in high impurity concentrations in the chlorosilane stream (metal-chlorides, BCl3, PCl3, CH4 etc.), which can require intensive purification by distillation.

Metals such as copper are known to act as a catalyst for the reaction between silicon and HCl, as it lowers the required temperatures and increases the yield (e.g. US patent 2009/0060818 A1). For the use as a catalyst, copper—or more likely copper in form of copper-chloride—is brought into contact with m.g. silicon particles and thus improves their reactivity with the HCl. Since, for this application, the metal such as copper is used only as a catalyst for the separate m.g. silicon stock, the applied concentrations of the metal/copper catalyst are in the lower per centum or per mill range. In this range case, metal such as copper has no function with respect to purification or gettering (i.e. filtering) of impurities from the m.g. silicon stock.

The use of a copper-silicon alloy for the purification of m.g.-silicon was proposed by Jerry Olson (U.S. Pat. No. 4.481.232; see also R. C. Powell, J. M. Olson, J. of Crystal Growth 70 (1984) 218; P. Tejedor, J. M. Olson, J. of Crystal Growth 94 (1989)579; P. Tejedor, J. M. Olson, J. of Crystal Growth 89 (1988) 220). Olson cast copper-silicon pieces of greater than 20% wt Si (for example 20-30% wt Si), which he placed in direct vicinity to a heated silicon filament. The inserted process gases (HCl—H2 mix) extracted silicon from the alloy in the form of a chlorosilane and Olson was able to deposit purified silicon on the silicon filament. Extraction of the silicon took place in a temperature range between 400 and 750C. It should be recognized that in the case of using metal silicon alloys, significant operational disadvantages can be encountered including instability of the alloy material both inside and outside of the purification process in the presence of crystallites in the allow material 16 (e.g. the case for two phases present in the alloy material).

### SUMMARY OF THE INVENTION

It is an object of the present invention to provide systems, processes and/or materials for the production of vapour deposition transport gas from a low purity silicon source to obviate and/or mitigate at least one of the above-presented disadvantages.

The present invention provides an apparatus and method for the production of chlorosilanes. In particular the present invention provides a method for the production of chlorosilanes from a feed gas operable to react with a source of silicon in form of a silicon-metal alloy to provide a gas comprising one or more chlorosilanes. The use of the term chlorosilanes herein refers to any molecular species homologous to silane having one or more chlorine atoms bonded to silicon. The source material is silicon in the form of a cast or sintered metal silicide or, in a more general sense, silicon-metal alloy.

The invention may be used as a stand alone apparatus for the generation of chlorosilanes or it may be connected to a Siemens type CVD reactor for the production of high purity silicon or it may be connected to any kind of subsequent chamber(s) for the deposition of silicon. The inlet gases may be pure HCl or may be a gas mix consisting of HCl, hydrogen and chlorosilanes. The process gases are actively transported into and out of the reaction chamber. The metal silicide used as a source material is actively heated to temperatures exceeding 150° C.

In one aspect the present invention provides an apparatus for the measured production of chlorosilanes comprising a chamber having an inlet through which a first gas mixture is received, configured to receive a silicon-metal alloy adapted to provide a source of silicon, the gas mixture comprising gaseous sources operable to react with the source of silicon to provide a gas comprising one or more chlorosilanes. The apparatus further comprises an outlet connected to the chamber and configured to allow the chlorosilanes therethrough and a heating device connected to the chamber and operable to actively heat the alloy, when received in the chamber. The apparatus further includes a control system connected to the chamber configured to control the amount and flow of the first gas mixture into the chamber, and further to control the heating device to actively heat the alloy to a temperature sufficient to facilitate the reaction of the first gas mixture with the alloy to produce the chlorosilanes, the chlorosilanes being operable to pass through the outlet.

In one embodiment the first gas mixture received within the chamber is selected from the group consisting of (i) hydrogen chloride, (ii) a mixture of hydrogen and hydrogen chloride and (iii) a mixture of hydrogen, hydrogen chloride and chlorosilanes.

In another embodiment the alloy that is adapted to provide a source of silicon is a silicon-metal alloy wherein the metal has a low vapour pressure and exhibits a limited reaction when mixed with HCl gas and hydrogen. The alloy may be selected from the group consisting of silicon-copper alloy, silicon-nickel alloy, silicon-iron alloy, silicon-silver alloy, silicon-platinum alloy, silicon-palladium alloy, silicon-chromium alloy or a combination thereof. In a further embodiment, the alloy includes at least one additive operable to accelerate the formation rate of the process gas.

In a further embodiment of the present invention the apparatus may further include an agitator configured to assist in the movement and transportation of gases within the chamber and through the outlet in the chamber. The apparatus may be an internal propeller located in the chamber or the agitator may be an external pump connected to the chamber.

In another embodiment, the heating device of the present invention is located within the chamber. Alternatively, the heating device may be located outside the chamber and is connected to the chamber and operable to heat the chamber.

In another aspect, the present invention provides an apparatus for the production of a gaseous source of silicon comprising a chamber having an inlet through which a controlled amount of an initial gas source is received and an outlet through which a gas is operable to pass, the chamber being configured to receive a silicon-metal alloy adapted to provide a source of silicon and a heating device operable to actively heat the alloy to a temperature sufficient to facilitate the reaction of the silicon with the initial gas source to produce a gaseous source of silicon, when the alloy is received in the chamber. The amount and the flow of the initial gas source may be controlled.

In an alternative aspect, the present invention provides a method for producing chlorosilanes comprising the steps of (i) placing a silicon-metal alloy comprising a source of silicon in a chamber; (ii) feeding a controlled amount of an inlet gas mixture comprising a source of chlorine into the chamber; (iii) actively heating the alloy to a temperature sufficient to generate a process gas source comprising at least one chlorosilane; and (iv) removing the process gas source comprising at least one chlorosilane from the chamber.

In one embodiment, the method includes heating the chamber to a temperature within the range of 150° C. to 1100° C., preferably to temperatures between 300 and 800C.

In a further embodiment, the alloy used in the method is a silicon-metal alloy wherein the metal has a low vapour pressure and exhibits a limited reaction in the applied temperature range when mixed with HCl gas and hydrogen. The alloy may be selected from the group consisting of silicon-copper alloy, silicon-nickel alloy, silicon-iron alloy, silicon-silver alloy, silicon-platinum alloy, silicon-palladium alloy, silicon-chromium alloy or a combination thereof. If the inlet gas contains STC (e.g. as an exhaust gas of a Siemens reactor) and/or a high yield of TCS is required, the silicon-metal alloy is selected in such a way that at least one component can act as a catalyzer for the back reaction of STC to TCS, as e.g. copper, nickel, or chromium.

Complicated and expensive refinement steps can be required in today's high purity silicon purification processes. Other disadvantages for today's processes are high impurity concentrations in the chemical vapour, which can require intensive purification by distillation. Hyper-eutectic alloys have been in prior art processes, however significant operational disadvantages exist including instability of the alloy material both inside and outside of the purification process. Contrary to present purification systems and methods there is provided a method for purifying silicon comprising: reacting an input gas with a metal silicon alloy material having a silicon percent weight at or below the eutectic weight percent of silicon defined for the respective metal silicon alloy; generating a chemical vapour transport gas including silicon obtained from the atomic matrix of the metal silicon alloy material; directing the vapour transport gas to a filament configured to facilitate silicon deposition; and depositing the silicon from the chemical vapour transport gas onto the filament in purified form.

Another aspect provided is a method for producing chemical vapour transport gas for use in silicon purification through silicon deposition, the method comprising: reacting an input gas with a metal silicon alloy material having a silicon percent weight at or below the eutectic weight percent of silicon defined for the respective metal silicon alloy; generating the chemical vapour transport gas including silicon obtained from the atomic matrix of the metal silicon alloy material; and outputting the vapour transport gas for use in subsequent silicon deposition.

A further aspect is a metal silicon alloy material having a silicon percent weight at a selected eutectic weight percent of silicon defined for the respective metal silicon alloy for use in a chemical vapour deposition (CVP) process, such that the presence of silicon crystallites in the alloy material is at or below a defined maximum crystallite threshold.

A further aspect is a metal silicon alloy material having a silicon percent weight at or below the eutectic weight percent of silicon defined for the respective metal silicon alloy for use in a chemical vapour deposition (CVP) process.

A further aspect is a chemical vapour reactor containing a metal silicon alloy material having a silicon percent weight at or below the eutectic weight percent of silicon defined for the respective metal silicon alloy.

A further aspect is an apparatus for producing chemical vapour transport gas for use in silicon purification through subsequent silicon deposition, the method comprising: a chamber configured for reacting an input gas with a metal silicon alloy material having a silicon percent weight at or below the eutectic weight percent of silicon defined for the respective metal silicon alloy and for generating the chemical vapour transport gas including silicon obtained from the atomic matrix of the metal silicon alloy material; and an output coupled to the chamber for outputting the vapour transport gas for use in subsequent silicon deposition.

A further aspect is a chemical vapour reactor containing a metal silicon alloy material having a silicon percent weight at or below the eutectic weight percent of silicon defined for the respective metal silicon alloy.

A further aspect is a chemical vapour reactor containing metal silicon alloy material having a silicon percent weight at a selected eutectic weight percent of silicon defined for the respective metal silicon alloy, such that the presence of silicon crystallites in the alloy material is at or below a defined maximum crystallite threshold.

It is an object to use a copper-silicon compound in order to make use of the catalytic nature of copper and to use a metal-silicon matrix to hold back/getter impurities.

Further example objects are: produce a copper-silicon source for use in a chlorination reactor, which (1) inhibits the formation of micro-cracks during casting, (2) has a desired shelf-time and inhibits significant oxidation, (3) inhibits swelling/expansion during the use in a chlorination reactor, (4) inhibits release of dust or powder during the use in chlorination reactors, (5) results in the production of high purity silicon above a selected resistivity threshold, and/or (6) can be handled and can be re-melted/cast (i.e. recycled) once significantly depleted of silicon.

### BRIEF DESCRIPTION OF THE DRAWINGS

The present invention will now be described in further detail with reference to the following figures:

FIG. 1 is a schematic of one embodiment of the apparatus of the present invention using an external heating device;

FIG. 2 is a schematic of an alternative embodiment of the apparatus of the present invention having an internal heating device;

FIG. 3 is a schematic of an alternative embodiment of the apparatus of the present invention including a control system;

FIG. 4 is an example phase diagram for the alloy material of FIG. 1;

FIG. 5 is an example matrix of the alloy material of FIG. 1;

FIG. 6 shows an alternative embodiment of eutectic properties of a metal alloy material for the apparatus of FIG. 1;

FIG. 7A shows undesirable hyper-eutectic properties of the alloy material for the apparatus of FIG. 1;

FIG. 7B shows an example result of the alloy material of FIG. 7A after use in the apparatus of FIG. 1;

FIG. 8 shows oxidation behaviour of eutectic copper-silicon alloy material of FIG. 3 versus oxidation behaviour of hyper-eutectic alloy of FIG. 7A;

FIG. 9A is a further embodiment of the alloy material of FIG. 5;

FIG. 9B shows a representation of the silicon content after being depleted in the vapour generation process of the apparatus of FIG. 1;

FIG. 10 is a block diagram for an example method of a chemical vapour production and deposition process of FIG. 1;

FIG. 11 is a block diagram of an example chemical vapour production process of FIG. 1;

FIG. 12 is an example casting apparatus for the alloy material of FIG. 1;

FIG. 13 is a block diagram for an example casting process using the apparatus of FIG. 12;

FIG. 14A is a diagram of resistivity measured though a thickness of deposited silicon obtained from eutectic or hypo eutectic alloy material used in the apparatus of FIG. 1; and

FIG. 14B is a diagram of resistivity measured though a thickness of deposited silicon obtained from eutectic or hypo eutectic alloy material used in the apparatus of FIG. 1.

### DETAILED DESCRIPTION OF THE PREFERRED EMBODIMENTS

It is recognised that a significant disadvantage of the copper-silicon alloy proposed by Olson is that the alloy appears to be hyper-eutectic and Applicant has confirmed that hyper-eutectic shows a tendency to oxidize when exposed to atmosphere and it swells and disintegrating during the chlorination process. The latter can be caused by the presence of substantive silicon crystallites and associated cracking interspersed with the eutectic copper-silicon matrix in the alloy material.

In the description that follows, a number of terms are used extensively, the following definitions are provided to facilitate understanding of various aspects of the invention. Use of examples in the specification, including examples of terms, is for illustrative purposes only and is not intended to limit the scope and meaning of the embodiments of the invention herein. Numeric ranges are inclusive of the numbers defining the range. In the specification, the word “comprising” is used as an open-ended term, substantially equivalent to the phrase “including, but not limited to,” and the word “comprises” has a corresponding meaning. Further, it is recognized that specific measures, as provided by illustrative example, can be approximate for purposes of controlling the pressure, temperature, and/or silicon percentage content in the alloy material 16. It is recognized that minor variance in the stated specific measures is accommodated for if the impact of such variance is insubstantial to processes 9,11 and/or the crystallite 120 content of the alloy material 16. For example, approximate temperatures can mean variation in the temperature by plus or minus a degree. For example, approximate silicon percent weights can mean plus or minus of the specific percent weight measure in the range of 0.01-0.2.

The present invention provides a method for the production of chlorosilanes. In particular the present invention provides a method for the production of chlorosilanes from a silicon-metal alloy. The use of the term chlorosilanes herein refers to any silane species having one or more chlorine atoms bonded to silicon.

The feed material is silicon in the form of a cast or sintered silicon-metal alloy. The invention may be used (i) as a stand alone apparatus for the generation of chlorosilanes or (ii) it may be connected to a Siemens type CVD reactor for the production of high purity silicon or (iii) it may be connected to any kind of subsequent chamber(s) for the deposition of silicon.

The inlet gases may be pure HCl or may be a gas mix consisting of HCl, hydrogen and chlorosilanes. The process gases are actively transported into the chamber and out of the chamber. The silicon-metal alloy used as a feed material is actively heated to temperatures exceeding 150° C.

To increase the yield of a specific chlorosilane component, the generated chlorosilanes might be separated by an STC-condenser or an STC to TCS convertor and the excess component might be fed back into the chlorination chamber.

In one embodiment the apparatus of the present invention includes a chamber having an inlet through which a first gas mixture is received, the chamber being configured to receive an silicon-metal alloy adapted to provide a source of silicon. The gas mixture comprises gaseous sources operable to react with the source of silicon to provide a gas comprising one or more chlorosilanes. The apparatus also includes an outlet connected to the chamber and configured to allow the chlorosilanes therethrough and a heating device connected to the chamber and operable to actively heat the silicon-metal alloy, when it is received within the chamber. The apparatus also includes a control system that is connected to the chamber and is configured to control the amount and flow of the first gas mixture into the chamber and further to control the heating device to actively heat the alloy to a temperature sufficient to facilitate the reaction of the first gas mixture with the alloy to produce the chlorosilanes, the chlorosilanes being operable to pass through the outlet.

In another embodiment the present invention provides a method for the production of a gaseous source of silicon comprising a chamber having an inlet through which a controlled amount of an initial gas source is received and an outlet through which a gas is operable to pass. The chamber is configured to receive a silicon-metal alloy adapted to provide a source of silicon. The apparatus further includes a heating device operable to actively heat the alloy to a temperature sufficient to facilitate the reaction of the silicon with the initial gas source to produce a gaseous source of silicon, when the alloy is received in the chamber.

The amount and flow of the initial gas source used in the apparatus of the present invention is controlled in order to control the productivity. The control of the amount and flow of the initial gas source may be provided by the use of a control system that is connected to the chamber, and thereby connected to the inlet of the chamber, either directly or indirectly, which controls the in flow of the initial gas source. Alternatively, the amount and flow of the initial gas source may be controlled at the source of the initial gas source or by means of controlling the inlet of the chamber, either directly or indirectly, to affect the gas flow. Additional control of the flow of the gas(es) within the chamber may be provided by a guiding system and/or an agitator located within, or connected to, the chamber. The agitator is described further below.

The present invention relates to the production of chlorosilanes, like dichlorosilane, trichlorosilane and silicontetrachloride, or a mixture of two or three of them. In particular, the present invention relates to the use of chlorosilanes for the purification of silicon using lower grade silicon (e.g. metallurgical grade silicon), bringing it into the gas phase in the form of a chlorosilane(s). The chlorosilanes may then be transported to a chemical vapour deposition chamber for the subsequent deposition of silicon, as described in Applicant's co-pending application entitled Apparatus and Method for Silicon Refinement.

To form the silicon-metal alloy used in the apparatus and method of the present invention, any metal might be used, provided that the metal has a low vapour pressure and shows a limited reaction with HCl gas and hydrogen, the metal should not form a gaseous species which tends to decompose on the hot filaments in the deposition chamber. Potential alloy forming metals include, but are not limited to, copper, nickel, iron, silver, platinum, palladium, chromium or combinations of these metals. In a preferred embodiment of the present invention the alloy is a silicon-copper alloy, of approximately eutectic copper-silicon composition or of hypo-eutectic copper-silicon composition or any composition in between.

The chlorosilane reactor described herein is a fixed bed reactor, but a person skilled in the arts will recognize that a moving bed or any kind of stirred bed arrangement can be used as well. The reaction between the initial process gases, e.g. HCl or mixture of hydrogen and HCl, takes place in the temperature range of 150° C. to 800° C., but might be higher for the use of higher melting point silicides. The upper temperature limit is dictated by the alloy composition in order to avoid a melting of the metal-silicide. The temperature and the gas flow are actively controlled, as described herein.

The chlorosilane chamber, also referred to herein as the chlorination chamber is sized and shaped to contain the alloy and to receive the initial process gases described herein. The chamber is equipped with a heating system. There are no size limitations for the chlorination chamber besides structural and mechanical considerations. It will be understood that the chlorination chamber must be connected to, or contain, a heating system configured to heat the chlorination chamber as described herein. The chamber may be cylindrical or box-shaped or shaped in any geometry compatible with described process. In one embodiment the chamber is cylindrical which provides for easier evacuation and better over-pressure properties. The chamber is configured to be heated either with an internal heater or with an external heater connected to the chamber, described below in further detail.

The chamber may be manufactured from any material operable to withstand the corrosive atmosphere and the range of operational temperature. To hold the silicon-alloy in place a charge carrier may be used, the charge carrier has to withstand the same atmosphere and temperature as the chamber and therefore may be made from similar material, providing it is not forming an alloy within the temperature used for the process.

The chamber includes an inlet and an outlet port for the process gases. Preferably, the inlet and outlet ports are designed in such a way that a uniform flow of the process gases is provided for the alloy enclosed in the chamber. Flow guiding systems may be used to improve the uniformity. The outlet port may be equipped with a mesh or a particle filter, depending on the application to which the gases leaving the chamber are to be used.

The process gases are actively forced into the chlorination chamber and transported out of the chamber. Any kind of agitator might be used to actively force the gases, such as a blower or a pump. It will be understood that the pump or blower is exposed to corrosive gases and therefore should be made of material that can withstand such conditions. The external pump may be positioned near the inlet or the outlet ports.

The silicon-metal alloy placed in the chamber is actively heated to an appropriate temperature to ensure a fast reaction of the process gases with the silicon and to guarantee a high output. As described above, the chamber may contain a heating device or may be connected to an external heating device. The heating device is used to heat the chamber and the alloy directly, i.e. the heating of the alloy is not affected by any other source apart from the heating device. The term ‘active heating’, or variations thereto, is used to describe a way of heating the alloy that is controlled, in which the temperature of the alloy is changed by changing the output of the heating device. It will be understood that formation of chlorosilanes is an exothermic reaction but the amount of heat generated provides only a small contribution to the heating of the silicon-metal alloy. Therefore control of the alloy temperature is primarily related to the heating device.

In the case of an internal heating device, a graphite heater might be used, preferably a SiC-coated one, or any other material suitable for use in a corrosive atmosphere. An internal heating device provides enhanced heating for a large diameter reactor and also allows operation of the chamber with lower wall temperatures which improves the corrosion resistance of the vessel material. If an external heating device is used any type of resistance heater may be used and connected to the chamber. The external heating device can be placed near the external wall of the chlorination chamber, it can be connected directly to it, or can even be part of the chamber wall. It will be understood, from the description provided herein, that good thermal contact between the heating device and the chamber is needed as well as providing a uniform temperature distribution inside the chamber. It will be further recognized that the number of heating devices and the position of them is designed in such a way that the heating of the alloy is performed as efficiently and as uniformly as possible. Preheating of the process gas at the gas inlet side can be used to improve the uniform heating of the alloy. In addition to the heating device, the apparatus may also include insulation that may be placed around the chamber and thus enclosing the heating element(s) and the chamber in order to reduce heat loss from the chamber. Since this insulation material is not exposed to process gases at any time, any state of the art insulation material may be used.

The temperature may be controlled by a state of the art temperature controller. The temperature of the silicon alloy should be higher than 150° C., preferably higher than 300° C., in order to achieve a high production rate, and should not exceed 1100° C. A person skilled in the art will recognize that, if a gas mixture of hydrogen and HCl is used as an inlet gas, temperatures too high will shift the equilibrium reaction between silicon and hydrogen chloride gas on the one side and chlorosilanes on the other side in the direction of solid silicon. In the case when a pure copper-silicon alloy is used, the temperature should not exceed 800° C. since this marks the eutectic temperature of copper-silicon alloy. It might be higher in the case of higher melting point metal-silicides used as feed stock. The temperature of the chamber may be controlled and/or monitored by thermocouples or any other kind of temperature sensor. The temperature sensors are preferably attached to the alloy however it will be understood that they are not required and that a person skilled in the art will be able to control the alloy temperature based on power consumption of the heating element(s). If the preferred chlorosilane product is trichlorosilane, lower temperatures should be applied in order to achieve a high selectivity for trichlorosilane. For copper-silicon alloy, the preferred temperature range for the formation of trichlorosilane would be in the range of 250 to 450C.

In one embodiment, the alloy is placed inside the chamber in such a way that the alloy surface is well exposed to the gas stream. The alloy is preferably copper and lower purity silicon, e.g. metallurgical grade silicon. However, it will be understood that higher purity silicon may also be used. The silicon concentration should be at least 10 at % in order to ensure high silicon productivity. But lower silicon concentrations might be used as well without compromising the process in principle, but obvious to someone skilled in the arts, the productivity and the yield would decrease. Additional additives may be added during the casting process of the alloy in order to accelerate the reaction time during the formation of chlorosilanes. Other additives that may be used include, but are not limited to, Chromium (Cr), Nickel (Ni), Iron (Fe), Silver (Ag), Platinum (Pt), and Palladium (Pd).

The alloy to be used may take any form, for example bricks, plates, granules, chunks, pebbles or any other shape, which allows an easy charging of the chamber and which preferably provides a large surface to volume ratio.

The initial process gases that are used are gases that are operable to react to form a chemical vapour transport gas adapted for transporting silicon. In one embodiment, the initial process gases provide a source of chlorine. In one embodiment the initial process gases are hydrogen and dry HCl-gas which are fed into the chamber through the inlet, and the alloy is a copper-silicide alloy. The ratio of the hydrogen and dry-HCl-gas is in the range of 1:9 to 9:1, preferably in the range of 1:5 to 5:1 or more preferably in the range of 1:2 to 2:1. In the case of this embodiment, the gas mix coming out of the chlorination apparatus can be fed directly into a silicon deposition chamber.

In another embodiment, the initial gas is pure HCl and the generated chlorosilane gas might be used for further purification or might be mixed with e.g. hydrogen and fed into a deposition chamber. In general, the gas fed in might contain chlorosilanes without harming the process.

The apparatus described herein may be operated under normal atmospheric pressure. Alternatively, the apparatus may be operated under increased pressure, for example in the range of 1 to 10 bar. In one embodiment, the apparatus is operated under an increased pressure of approx. 5 bar. A person skilled in the process will recognize that an increased pressure will enhance the chlorosilane productivity on the one hand and reduce the evaporation of volatile metal chlorides (for example, but not exclusively, AlCl3) on the other hand.

Prior to the process, the chlorination chamber is preferably evacuated to provide an oxide-free atmosphere for the process. A person skilled in the art will recognize that the vacuum system might be exposed to corrosive gases such as HCl or chlorosilanes, which requires corrosion resistant vacuum components. Alternatively, an oxide-free atmosphere is provided by purging the chamber with an oxide and moisture-free purge gas.

Once supplied, the initial process gases react with the silicon at the surface of the alloy. As a result, chlorosilanes, for example trichlorosilane, silicontetrachloride or dichlorosilane, are generated by the reaction of the H2-HCl mixture with the silicon alloy. By way of this reaction a chemical vapour transport gas is provided for transporting silicon. In simplified form, the reaction can be written as follows:

Si+3 HCl→SiHCl3+H2

Typical by-products of this reaction are SiH2Cl2 (DCS) and SiCl4 (STC).

It will be understood that the method described herein is used for the production of chlorosilanes. The apparatus of the present invention may be used for several applications as described further below, including for example, but not limited to, as a stand alone apparatus for the production of chlorosilanes, in a closed loop system, as described in co-pending application entitled Apparatus and Method for Silicon Deposition, and in a chemical vapour deposition process for poly-silicon, for example like a Siemens-type CVD reactor as disclosed in U.S. Pat. Nos. 2,999,735; 3,011,877; and 6,221,155.

In one application, in use in a chemical vapour deposition process for poly-silicon, the chlorination chamber may be combined with any other system that requires a source of chlorosilanes, for example a Siemens type poly-silicon deposition reactor. In this use the chamber can be coupled with a Siemens reactor in such a way that the outlet port of the chlorination chamber is connected to the inlet port of the Siemens reactor. It also allows the set-up of multi-chamber assemblies, e.g. several chlorination chambers feeding one deposition reactor, or one large chlorination chamber connected to several deposition reactors.

In another application, the chlorination chamber may be connected to a deposition chamber in such a way that the two reactors form one closed loop system. This arrangement, described in co-pending application entitled Apparatus and Method for Silicon Deposition, minimizes the transport length and the corresponding instrumentation and equipment and reduces potential sources of contamination.

In another application the apparatus may be used as a stand alone apparatus. The apparatus may be used as a stand alone production of high purity chlorosilanes in such a way that the produced chlorosilanes are fed into a fractional distillation process, for example. Due to the fact that copper is an excellent getter for impurities and in addition, acts as a catalyst for the generation of chlorosilanes, the use of silicon-copper-alloy as a feed material results in a high productivity.

Referring now to the accompanying Figures, the apparatus of the present invention is indicated generally at numeral 10.

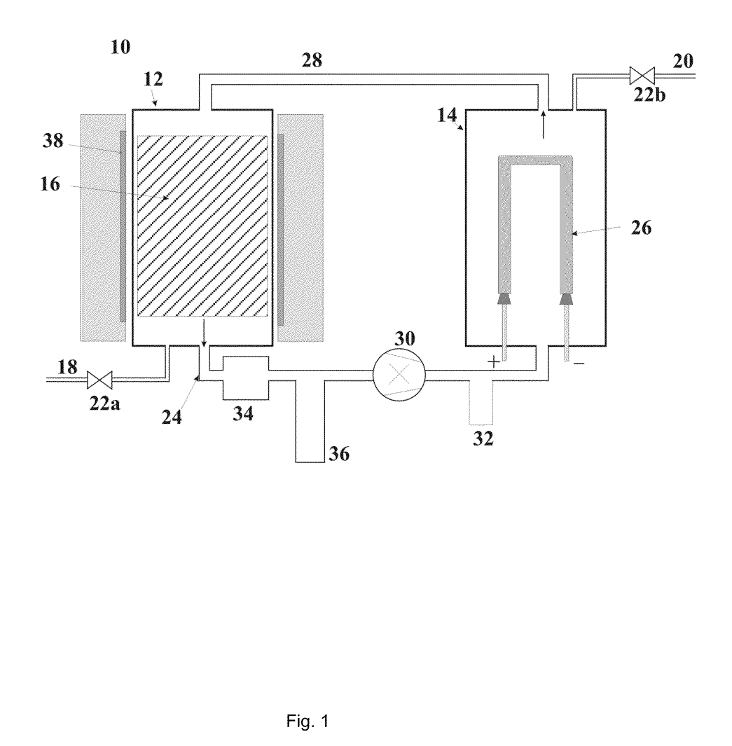

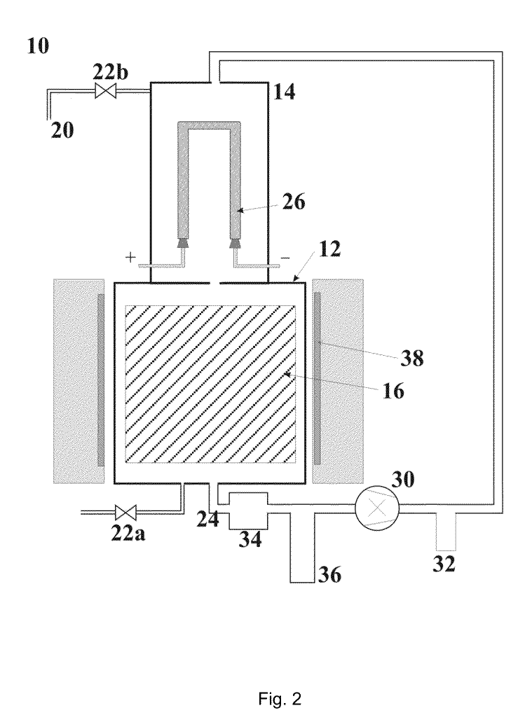

FIG. 1 shows the apparatus having a chamber 12 that provides a gas tight atmosphere. The chamber may be opened at the top or the bottom by removing the top or bottom plates, or it might be equipped with any other type of gas tight doors or windows. As stated above, the alloy 16 is placed inside the chamber 12. The external heating device 6, to which the chamber 12 is connected provides a controlled temperature inside the reactor. Additional insulation may be added to reduce heat loss to the outside, as shown in FIGS. 1 and 2 at numeral 18. The temperature in the chamber 12 is controlled and/or monitored by thermocouples, not shown, or any other kind of temperature sensor.

The chamber 12 includes an inlet 22 and an outlet 23, it will be understood that depending on the installation and arrangement, inlet 22 and outlet 23 may be switched. A guiding system 20 for the gas flow may be installed to improve the flow. Since in most cases, the chamber will be larger in diameter than the inlet pipe, the guiding system will change the flow at the inlet to provide a uniform flow over the whole cross section of the chamber. The guiding system may be a plate with an appropriate number of holes to allow for gas flow through the plate. The system may be formed from material withstanding the temperature and the corrosive gases might be used. Additional gas supply lines 28, 29 may be connected to the chamber 12 to allow for the passage of gas into the chamber 12, such gas may include the initial process gas and /or purge gases. Further, an evacuation system may be installed using inlets 22, 23, 28, or 29. Any state of the art vacuum system might be used. A person skilled in the art will recognize that the vacuum system might be exposed to corrosive gases, which requires corrosion resistant vacuum components. Located along the inlets/outlets 22, 23 and along the gas supply lines and operable to control the flow of gas within them are valves 24. Valves 24 may be included at any point where control of the flow of gas is required. A pump or blower 26 provides a forced flow within the chlorination chamber.

FIG. 2 shows a schematic of an alternative embodiment of the apparatus of the present invention in which the heating device 6 is integrated within the chamber 12. This arrangement includes electrical feed-throughs 30. As stated above, the apparatus of the present invention may also include additional instrumentation, for example one or more of a condenser to remove e.g. metal-chlorides 32, a particle filter 34, a gas analyzing system, or a chlorosilane converter (for example, but not exclusively, an STC to TCS converter) 36 may be added to the system, if further use of the chlorosilanes requires it. Depending on the application, the converter 36 may be placed on the inlet side (for example, if a mixture of H2, HCl and chlorosilanes are fed into chamber) or on the outlet side.

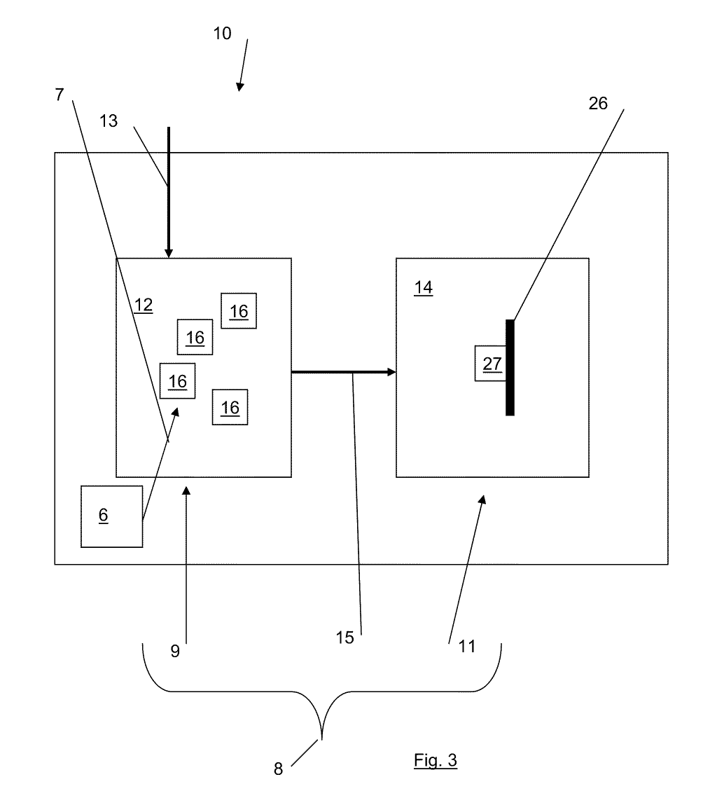

FIG. 3 is a schematic of the chamber 12, with inlet 22 and outlet 23, connected to a control system 40. The control system 40 may be configured to control the amount and flow of the initial gas source into the chamber 12. In addition, the control system 40 may be configured to control the heating device, not shown, that is connected to the chamber 12.

The following examples are provided to further describe the apparatus and use of the apparatus of the present invention. These are examples only and are not meant to be limiting in any way.

### EXAMPLE 1

A cylindrical quartz chlorination chamber of 14 cm diameter and 30 cm height was charged with a total of 1.15 kg of silicon-copper alloy 16, consisting of roughly 5 cm3 chunks of 50 wt % silicon alloy produced by conventional casting technique. After proper evacuation and pre-heating of the alloy to 280C, dry HCl was introduced into the chamber and fluxed at a rate of 1 litre per minute for 45 minutes. The output gas stream was combined with the HCl flux and recirculated back to the inlet at a rate of 0.5-1.5 liters per second by means of a membrane pump integrated into the piping. Samples of the process gas stream were analyzed by gas chromatography and found to be comprised of 45% trichlorosilane (TCS), 6.5% HCl, 2.5% silicon tetrachloride (STC) and less than 1% dichlorosilane (DCS) with the remainder being hydrogen.

### EXAMPLE 2

In the chlorination chamber 12 and alloy charge 16 of example 1, the chamber was evacuated of process gas and refilled with 100% hydrogen. After heating the alloy to approximately 300C, a total of 5 L of HCl was added to the chamber over a period of 1.5 h and the process gas was recirculated to the inlet, as discussed in example 1, above. Analysis of the process gas stream indicated a steady build in the chlorosilane content of the process gas stream corresponding to >99% of each addition of HCl reacting to form chlorosilanes. At the end of the 1.5 h, the gas composition was 6% TCS, 3.6% STC, less than 0.2% HCl or DCS, with the remainder being hydrogen.

### EXAMPLE 3

The alloy 16 of example 2 was allowed to cool to 220C while HCl was fluxed at a rate of 3-6 L/h. After two hours, the composition of the gas stream was 17% TCS, 4.7% STC, less than 0.3% either HCl or DCS with the remainder being hydrogen.

### EXAMPLE 4

A chlorination chamber 12 of 34 cm diameter and 50 cm height was charged with 25 bricks of silicon-copper alloy 16, the total weight of the alloy was 12 kg, and the concentration of silicon was 30 wt % or 3.6 kg. The alloy bricks had been produced by conventional casting technique. The bricks were placed equally spaced in the center of the chlorination chamber. After proper evacuation and filling the chamber with process gases, the chlorination chamber was connected to a Siemens type poly-silicon deposition chamber, the volume of the system was 150 l. The silicon-metal alloy 16 was heated to a temperature of 300 to 400C and the process gases were circulated in a closed loop system between the chlorination and a deposition chamber. The temperature of the alloy and the temperature of the filaments were controlled independently and did not influence each other. The chlorosilanes, e.g. trichlorosilane, which had been generated in the chlorination chamber, were consumed in the deposition chamber, and the exhaust gases from the deposition process were used to generate new chlorosilanes by reacting with the silicon-alloy. The gases circulated for 48 hours, forced by a blower integrated into the piping between deposition and chlorination chamber. During these 48 hours, 1.6 kg of silicon had been extracted from the silicon-copper-alloy and had been deposited in the deposition reactor. This amount of silicon is equivalent to approx. 7.75 kg of TCS which corresponds to 1290 litres of gaseous TCS. The alloy bricks, which had been inserted in the form of solid pieces, formed a porous, rather spongy material, which allows a good gas exchange, even when the silicon has to be extracted from the inner areas of the alloy bricks. At the end of the chlorination process, a significant swelling of the alloy bricks is observed and part of them had fallen apart. After the process was stopped and the reactor was cooled down, the gases were replaced by inert gas. No copper was detected in the deposited silicon, the silicon was analyzed by GDMS (Glow Discharge Mass Spectroscopy, the detection limit for copper is 50 ppb) by an independent, certified laboratory (NAL—Northern Analytical Lab., Londonderry, N.H.). The analysis clearly indicates that the copper stays in the solid phase and only the silicon is going into the gas phase and is extracted from the alloy.

### EXAMPLE 5

15 kg of copper-silicon with a silicon concentration of 30 at % were placed in a chlorination chamber 12 in the form of 47 bricks 16. The chamber was connected to a silicon deposition reactor in order to consume the generated chlorosilanes and to provide the system with fresh HCl, generated during the deposition process. Within 15 hours, 1.15 kg of silicon had been extracted from the alloy. Since the deposition conditions had been chosen in such a way that deposition took place from TCS, the extracted silicon amounted to 5.5 kg of TCS with an equivalent of approx. 920 litres of TCS or an average TCS production of 1 l/min.

### EXAMPLE 6

6 kg of copper-silicon with a silicon concentration of 50 at % were placed in a chlorination chamber 12 in the form of 18 bricks 16. The chamber was connected to a silicon deposition reactor in order to consume the generated chlorosilanes and to provide the system with fresh HCl, generated during the deposition process. Within 44 hours, 1.6 kg of silicon had been extracted from the alloy. Since the deposition conditions had been chosen in such a way that deposition took place from TCS, the extracted silicon amounted to 7.7 kg of TCS equivalent to approx. 1.285 litres of TCS or an average TCS production of 0.48 l/min. The maximum TCS production, according to the deposited silicon, reached 0.57 l/min. During the process, the alloy did swell and formed a spongy, rather loosely connected composit.

### EXAMPLE 7

47 kg of eutectic copper-silicon (Si-concentration 16% wt) 16 were placed in a chlorination chamber 12 in form of 103 plates. Thickness of the plates was 6 mm. The chamber was connected to a silicon deposition reactor in order to consume the produced chlorosilanes and to provide the system with fresh HCl, generated during the deposition process. Within 70 hours, 4 kg of silicon had been extracted from the eutectic copper-silicon and transferred into the gas form. The eutectic copper-silicon was heated to a temperature of 350 to 450C. The initial gas composition which was fed into the chlorination chamber was a mixture of H2 and HCl (60% H2 and 40% HCl). During the process, the chlorination chamber was fed only with the off-gas from the deposition reactor. After the process, the integrity of the eutectic copper-silicon plates was fully given, no swelling or powdering of the plates was observed.

54 kg of hypo-eutectic (pure eta-phase, Si-concentration 12% wt) copper-silicon 16 was placed in a chlorination chamber 12 in form of 110 bricks. Temperature during the chlorination process was in the range of 270 to 450C. The chamber was connected to a silicon deposition reactor in order to consume the produced chlorosilanes and to provide the system with fresh HCl, generated during the deposition process. Within 117 hours, 4 kg of silicon had been extracted from the hypo-eutectic copper-silicon and transferred into the gas form. The initial gas composition which was fed into the chlorination chamber was a mixture of H2 and HCl (60% H2 and 40% HCl). During the process, the chlorination chamber was fed only with the off-gas from the deposition reactor. After the process, the integrity of the hypo-eutectic copper-silicon bricks was fully given, no swelling or powdering of the bricks was observed.

Alternative Embodiments of the Alloy Material 16 and Apparatus 10 with Methods 8

Referring to FIG. 1, provided is an alloy material 16 for example use as a source for the production of chlorosilane containing transport gas 15. Described is a general method for the production of chlorosilanes 9 (in the transport gas 15) from eutectic and/or hypo-eutectic metal-silicon alloy material 12, as well as the general desired properties of the alloy material 16 and examples of the alloy material 16 production, use in an example chlorination-deposition process 8, and recycling. It is recognized that the following description provides for a metal/silicon alloy material 16 with desirable properties for use in CVD process 8 implemented in a CVD apparatus 10, for example. The following examples of the CVD process 8 and corresponding apparatus 10 are described as chlorination 9 -deposition 11 for discussion purposes only. It is contemplated that CVD process 8 (including vapour production 9 and deposition 11) and corresponding apparatus 10 other than directed to chlorination can also be used with the alloy material 16, as desired. It is recognized that chlorosilanes are one example of the transport gas 15 produced as a result of reaction of the silicon in the alloy material 16 with the input gas 13 (e.g. containing HCl). Other examples of the transport gas 15 can include other halides (e.g. containing reactive forms of fluorine, bromine, and/or iodine, etc, with silicon—HBr, HI, HF, etc.). Accordingly, certain modifications with respect to the temperature, the gas composition, the pressure, and/or other related process 9,11 parameters could be required due to the different boiling points of the hydrogen halides and the different reactivities between the input gas(es) 13 and the silicon of the metal silicon alloy material 16. Further, compatibility with certain materials used for the process 9,11 or during the process 9,11 has to be provided for.

Examples of CVD are such as but not limited to: classified by operating pressure; classified by physical characteristics of vapor; plasma methods; Atomic layer CVD (ALCVD); Hot wire CVD (HWCVD); Hybrid Physical-Chemical Vapor Deposition (HPCVD); Rapid thermal CVD (RTCVD); and Vapor phase epitaxy (VPE). The operating pressure and/or temperature of the transport gas generation process 9 can be selected so as to be compatible with (i.e. facilitate) the formation of the transport gas 15, be compatible with the melting point of the alloy material 16 (e.g. the temperature of the process 9 is below the melting point temperature of the alloy material 16), and/or be compatible and/or otherwise facilitate the diffusion of silicon through the matrix 114 in preference (e.g. greater than—for example at least twice as much, as least four times as much, at least an order of magnitude as much, as least two orders of magnitude as much) the diffusion of any impurities contained in the alloy material 16.

In general, Chemical Vapor Deposition (CVD) is a chemical process 8 used to produce high-purity, high-performance solid materials 27 such as deposited silicon 27 of a desired purity. The process 8 (e.g. including chlorination 9 -deposition 11 processes) can be used in the semiconductor and solar industries to produce the silicon 27 of desired purity and shape. In a typical CVD process 8, a silicon substrate 26 (e.g. filament such as a wafer or shaped rod) is exposed to one or more volatile precursors (i.e. obtained from transport gases 15 produced by the chlorination process 9) to facilitate the deposition process 11 of the silicon 27 onto the substrate 26. Accordingly, in the deposition process 11 the chlorosilanes in the process gas 15 reacts and/or otherwise decomposes on the substrate 26 surface to produce the desired deposited silicon 27.

Further, the process 8 can also be used for the production of high purity, cost efficient silicon 27, such as applied to the refining of raw silicon, for example, but not limited to, metallurgical grade silicon of approx. 98 to 99.5% purity provided as a component of the metal/silicon alloy material 16, into high purity silicon 27 having a purity with respect to metallic impurities better than a selected purity level (e.g. 6N). The process 8 can also be used for the refining and production of solar grade silicon 27 which can be used, for example, as base material for forming multi-crystalline or single crystalline ingots for wafer manufacturing.

Referring again to FIG. 1, input gases 13 (e.g. providing a source of chlorine including hydrogen gas and dry HCl-gas) are directed into a chemical vapour producing (e.g. chlorination) region 12 (e.g. chamber, portion of a chamber, etc.) of the vapour-deposition (e.g. chlorination-deposition) apparatus 10 in order to come into contact with the alloy material 16 (e.g. copper-silicide alloy). The input gases 13 are gases that are operable to react with the alloy material 16 to form the chemical vapour transport gas 15 for transporting silicon from the alloy material 16 in the vapour production region 12 to a deposition region 14 (e.g. chamber, portion of a chamber, etc.) of the apparatus 10. It is recognised that the region 12 and region 14 can both be in the same or different reaction chambers (e.g. of a CVD process).

As an example of the above, process 8 and apparatus 10 provides for the refinement of silicon via the production of chlorosilanes containing transport gas 15, and the deposition of high purity silicon 27 on a silicon filament 26. The chlorosilane gas 15 is formed 9 in the one region 12, in which the lower purity silicon is placed in the form of the silicon alloy material 16, and higher purity silicon 27 is deposited 11 in the other region 14, where heated silicon filament(s) 26 are located. The use of the term chlorosilanes herein refers to any silane species having one or more chlorine atoms bonded to silicon. The produced chlorosilanes may include, but are not limited to, dichlorosilanes (DCS), trichlorosilanes (TCS) and silicon tetrachloride (STC). For example, TCS is used for the deposition of the purified silicon 27.

Further, the above-described process 8, use of the alloy material 16 can facilitate the removal of metal impurities from the deposition process 11. In particular, the deposition method can provide high purity silicon 27 with the removal of metallic impurities that are resident in the alloy material 16. Some metallic impurities do not form volatile chlorides, like e.g. Fe, Ca, Na, Ni, or Or and thus stay with the alloy material 12 in the chlorination region 12. Others, which form chlorides with a rather low boiling point (e.g. Al or Ti), will evaporate, but do more preferably condensate on cold surfaces than being deposited on the hot silicon filament 26 in the deposition region 14.

### Example CVD Process 8 Parameters

Once the input gas stream 13 has entered region 12, heat 7 can be actively applied/supplied to the alloy material 16 using a heating device 6, and when the temperature of the alloy material 16 is greater than a selected temperature T (e.g. 150° C.) the input gas reacts at the surface of the alloy material 16 to produce a gaseous source of silicon, i.e. chlorosilanes transport gas 15. The chlorosilane gas 15 then exits the region and is directed to the region 14.

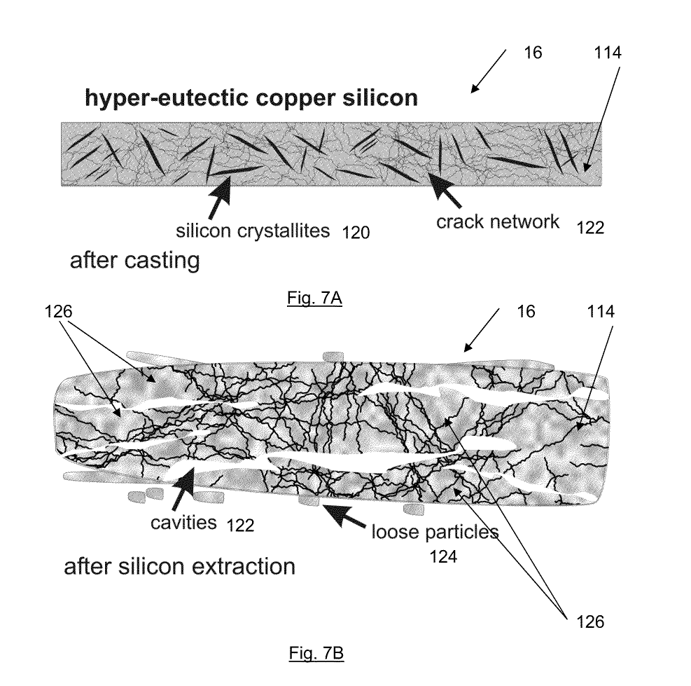

In region 14 there is located at least one shaped (e.g. U-shaped) filament 26 upon which silicon 27 is deposited. The filament 26 is heated to a temperature in the range of 1000° C. to 1200° C. to allow for silicon deposition 11. To form the silicon-metal alloy material 16 used in the apparatus 10 and process 8 using the selected percent weight of silicon such that the presence (if any) of crystallites 120 (see FIG. 7A) in the alloy material 16 is at or below a selected maximum crystallite threshold (it is recognised that for silicon at or below the eutectic silicon % wt composition—eutectic or hypo eutectic matrix 114—the presence of crystallites 120 in the alloy material 16 should be negligible if any), any metal might be used, provided that the metal has a vapour pressure lower than a defined vapour pressure threshold and shows/exhibits a limited reaction with HCl gas and hydrogen. In the case of copper silicon alloy material 16, the maximum crystallite threshold can be defined as a percent weight of silicon in the alloy material 16 as less than 20%, less than 19%, less than 18%, less than 17.5%, less than 17%, or less than 16.5%, for example.

Further, for example, the metal should not form a gaseous species which tends to decompose on the hot filaments 26 in the deposition region 14. Preferably the metal used does not form a volatile metal-chloride in the range of the working temperature of the chlorination region 12. Potential alloy material 16 forming metals include, but are not limited to, copper, nickel, iron, silver, platinum, palladium, chromium or combinations of these metals. In a preferred embodiment of the present invention the alloy material 16 is a silicon-copper alloy.

As a result, chlorosilanes gas 15, for example trichlorosilane (TCS), silicon tetrachloride (STC) or dichlorosilane (DCS), is generated by the reaction 9 of the H2-HCl mixture 13 with the silicon alloy material 16. By way of this reaction 9 the chemical vapour transport gas 15 is provided for transporting silicon. In simplified form, the reaction 9 can be written as follows:

Si+3 HCl→SiHCl₃+H₂

Typical by-products of this reaction can be SiH2Cl2 (DCS) and SiCl4 (STC).

The chlorosilanes gas 15 is transported actively from the chlorination region 12 into the deposition region 14. The deposition rate 11 of silicon 27 can be controlled by a flow rate (i.e. gas exchange rate) between the chlorination and the deposition regions 12,14. The flow rate may be controlled by a control system that is connected to the apparatus 10 and is configured to control the flow of gases 13,15 within and to the chlorination and deposition regions 12,14. Alternatively flow rate can be controlled by the H2 to HCl ratio or other ratio of the input gases 13, or flow rate can be controlled by the temperature of the filament 26. The deposition rate 11 can also depend on the amount of silicon-metal alloy material 16 placed into the chlorination region 12, the temperature T of the alloy material 16, and/or the % wt of silicon in the alloy material 16.

As stated above, the gaseous silicon in the transport gas 15 is then deposited on the heated filaments 26 in the deposition region 14 as high purity silicon 27. The types of filaments 26 that may be used include, but are not limited to, silicon, graphite, molybdenum, tungsten or tantalum filaments. The filaments 26 may be of any shape that allows for subsequent deposition 11 of the silicon 27 thereon. The temperature of the filament 26 is controlled and maintained in the range of 1000 to 1200C. In simplified form, the decomposition 11 looks like:

SiHCl3+H2ΔSi+3 HCl

Typical by-products of this reaction 11 are SiH2Cl2 (DCS) and SiCl4 (STC).

Further, the silicon-metal alloy material 16 may be placed in the chlorination region 12 in form of a fixed bed arrangement or in form of a travelling or any other kind of stirred bed configuration. Recharge of the silicon-metal alloy material 16 during the process 9 might be provided using a recharge port in the chlorination region.

### Structure of Metal-Silicon Alloy Material 12

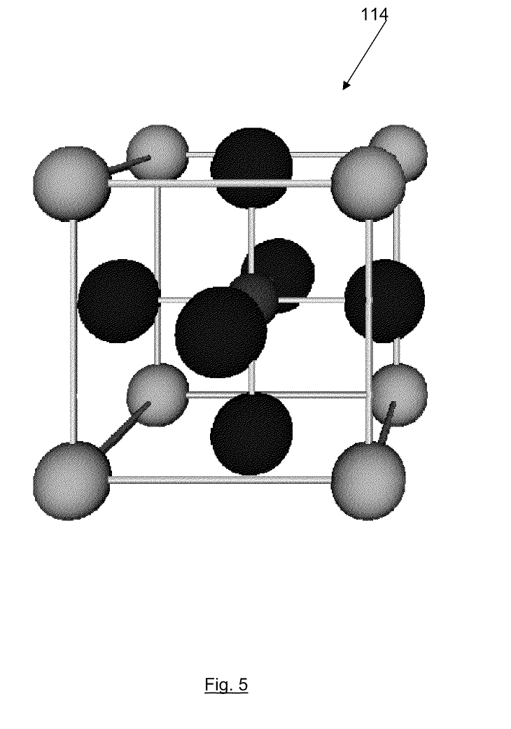

In general, the melting point of a mixture of two or more solids (such as a metal-silicon alloy material 16, hereafter referred to as alloy material 16) depends on the relative proportions of its constituent elements A,B, see FIGS. 5,6. It is recognized that the alloy material 16 is such that the predominant/major constituent element(s) B are metal (e.g. copper Cu, nickel Ni, iron Fe, silver Ag, Platinum Pt, Palladium Pd, chromium Or and/or a combination thereof) and the minor constituent element A includes silicon Si. Accordingly, metal silicon (Si) alloy material 16 can be characterized as a metal/silicon alloy in which the silicon occupies a minor volume fraction (e.g. 10-16%) of the alloy structure 114 as compared to the volume fraction of the metal (e.g. Cu).

An eutectic or eutectic alloy material 16 is a mixture at such proportions that the melting point is a local temperature T minimum, which means that all the constituents elements A,B crystallize simultaneously at this temperature from molten liquid L solution. Such a simultaneous crystallization of an eutectic alloy material 16 is known as an eutectic reaction, the temperature T at which it takes place is the eutectic temperature T, and the composition and temperature of the alloy material 16 at which it takes place is called the eutectic point EP. In terms of the alloy material 16, this can be defined as a partial or complete solid solution of one or more elements A,B in a metallic matrix/lattice 114 (see FIG. 5). Complete solid solution alloys give a single solid phase microstructure, while partial solutions give two or more phases that may be homogeneous in distribution depending on thermal (heat treatment) history. It is recognized that the alloy material 16 has different physical and/or chemical properties from those of the component elements A,B. In terms of matrix/lattice 114, this can be defined as a defined ordered constituents A,B structure (e.g. crystal or crystalline) of solid material, whose constituents A,B as atoms, molecules, or ions are arranged in an orderly repeating pattern extending in two and/or all three spatial dimensions.

Eutectic or hypo-eutectic metal-silicon alloys 16 may be distinguished from hyper-eutectic alloys in that the eutectic or hypo-eutectic alloys 16 do not demonstrate silicon microcrystal 120 formation when the cast alloy is cooling, as would be observed in the case of hyper-eutectic alloys. This lack of microcrystals 120 can provide an advantage when the eutectic or hypo-eutectic silicon-copper alloy 16 is used as source material 16 for the process 8 described herein, for example.

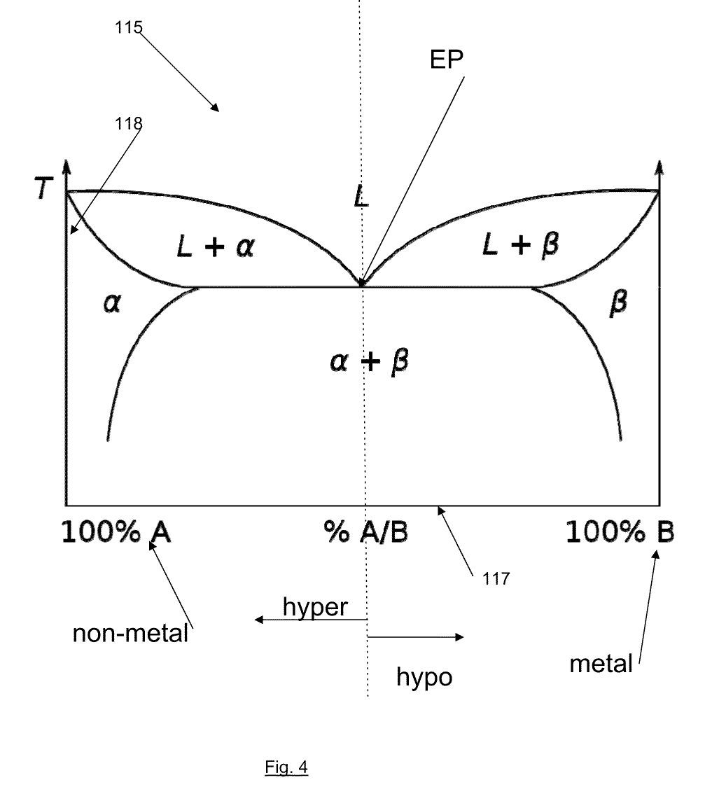

Referring to FIG. 4, shown is an example equilibrium phase diagram 115 for a binary system comprising a mixture of two solid elements A,B, where the eutectic point EP is the point at which the liquid phase L borders directly on the solid phase α+β. Accordingly, the phase diagram 115 plots relative weight concentrations of the elements A and B along the horizontal axis 117, and temperature T along the vertical axis 118. The eutectic point EP is the point at which the liquid phase L borders directly on the solid phase α+β (e.g. a homogeneous mixture composed of both A and B), representing the minimum melting temperature of any possible alloy of the constituent elements A and B. It is recognized that the phase diagram 115 shown is for a binary system (i.e. constituents A,B), however it is contemplated that other systems (e.g. tertiary A,B,C and higher) can be used to define the alloy material 16, such that Si is for example included in the minor constituent element A in combination with metal (or a mixture of different metals) as the major constituent element (or element group) B (e.g. Si is the minor constituent element A as compared to the major constituent element/element group comprising one or more different metals “B”. Examples of the alloy material 16 are alloys such as but not limited to: silicon-copper alloy; silicon-nickel alloy; silicon-iron alloy; silicon-silver alloy; silicon-platinum alloy; silicon-palladium alloy; silicon-chromium alloy; and/or a combination thereof (e.g. Cu—Ni—Si alloy). Further, it is recognized that the alloy material 16 can be a hypoeutectic alloy in which the percent weight (wt %) composition of the silicon constituent(s) A is to the left hand side of the eutectic point EP on the equilibrium diagram 115 of a binary eutectic system (i.e. those alloys having a percent weight (wt %) composition of the silicon A less than the eutectic percent weight (wt %) composition of the silicon A. Accordingly, at any position where the hypoeutectic alloy exists the solute (i.e. silicon A) concentration at that position is less than the solute (i.e. silicon A) concentration at the eutectic point EP. Further, it is recognized that the alloy material 16 can be a hypereutectic alloy in which the percent weight (wt %) composition of the silicon constituent(s) A is to the right hand side of the eutectic point EP on the equilibrium diagram 115 of a binary eutectic system (i.e. those alloys having a percent weight (wt %) composition of the silicon A greater than the eutectic percent weight (wt %) composition of the silicon A. Accordingly, at any position where the hypereutectic alloy exists the solute (i.e. silicon A) concentration at that position is greater than the solute (i.e. silicon A) concentration at the eutectic point EP. Hyper eutectic alloy materials 16 are considered multi-phase (e.g. two phase) alloys (e.g. heterogeneous) while hypo eutectic alloy materials 16 are considered single phase (e.g. one phase) alloys (e.g. homogeneous).

It is recognised that the eutectic or hypo-eutectic silicon-metal alloy 16 can have resistance to cracking 122 as the cast alloy cools, which is due, at least in part, to the substantial absence of silicon microcrystals 120 in the source material 16 (see FIGS. 7A,B). The reduction in cracking 122 can inhibit access of ambient air and moisture to the interior of the cast piece 16, and thus can reduce absorption of oxygen and/or moisture once the cast alloy 16 is exposed to the ambient atmosphere. This may enhance the shelf-life of the cast alloy 16. Further, the release of oxygen or other impurities introduced in to the alloy material 16 (due to degradation by exposure to ambient conditions) into the chlorination region 12 can be reduced, thereby helping to improve the purity of the chlorosilane mixture in the process gas 13 and helping to improve the purity of the deposited silicon 27, for example.

### Metal-Si Alloy Material 16

It is recognised that different metal silicon alloy materials may be useful in the apparatus 10 for transport gas 15 production and silicon 27 deposition. For example, nickel silicon, platinum silicon, chromium silicon, and/or iron silicon may be useful alloy materials, wherein the metal silicon alloy materials 16 are designed such that the percent weight of silicon in the alloy material 16 is selected to be approximately at or below the eutectic composition. It is recognised that the percent weight of silicon in the metal silicon alloy material 16 is chosen so that the amount of silicon crystallites 120 is at or below a specified maximum crystallite threshold. It is recognised that any silicon percent weight in the alloy material above the specified maximum crystallite threshold would introduce crystallites 120 of sufficient number, size, and/or distribution that would be detrimental to the structural integrity of the alloy material due to incompatible/dissimilar thermal expansion properties of the crystallites 120 and the eutectic matrix 114. As already discussed, the presence of crystallites 120 in the alloy material 16 is detrimental to the structural integrity of the alloy material due to the cracks 122 that develop due to the presence of the crystallites 120 of sufficient number, size, and/or distribution that are above the specified maximum crystallite threshold.

It is also recognised that the metal silicon alloy material 16 can have two or more metals in the matrix 114, such as any combination of two or more metals selected from the group including copper, nickel, chromium, platinum, iron, gold, and/or silver, etc. Further, it is recognised that copper of the metal silicon alloy material 16 could be the largest percent weight out of all the other alloy constituents (for example in the case of two or more metals) including silicon.

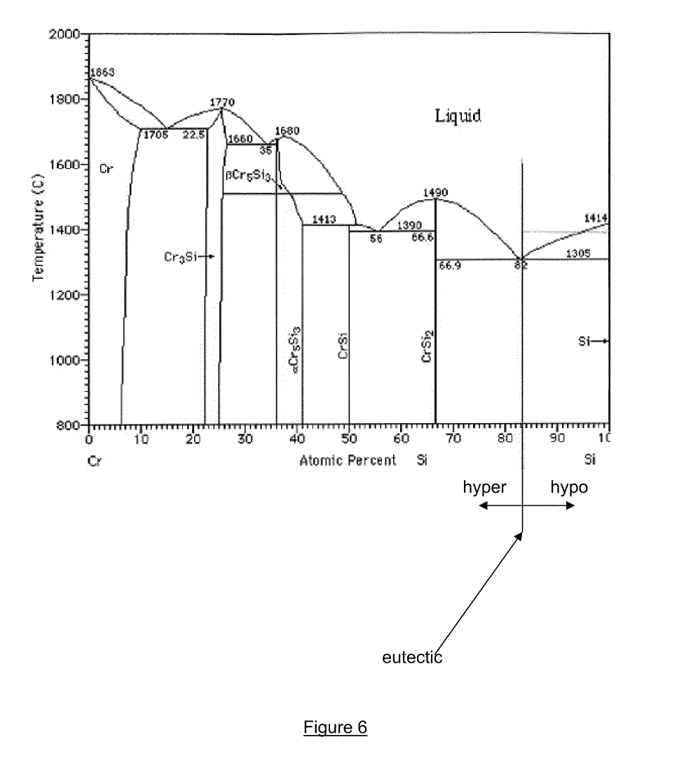

Referring to FIG. 6, shown is example eutectic properties and ranges for the metal chromium silicon alloy material 16.

### Cu—Si Alloy Material 16 Examples

A further example of the alloy material 16 is copper Cu and silicon Si that form a rather complex phase diagram 115, at least one eutectic point EP is known (Si is approximately 16% wt, Tm=800C) and several intermetallic phases are formed. The most prominent of the intermetallic phases is the eta-phase, which consists of Cu3Si (with a certain phase width, depending on the temperature). The melting point of the intermetallic Cu3Si phase has been reported to T=859C. In the hyper-eutectic range (e.g., Si-concentration greater than approximately 16% wt) copper Cu and silicon Si are completely miscible in the liquid over the whole concentration range up to pure silicon Si, but during cooling down, silicon Si crystallizes in form of interspersed crystallites 120 (needles or plates of multiple millimeter length), which are embedded in the matrix 114 of the eutectic alloy material 16. In the concentration range below the eta-phase (i.e. hypo-eutectic composition with Si less than approximately 16% wt), at least 5 additional intermetallic compounds are known, but most of them have been identified only for the high temperature range.

In any event, it is recognized that the Cu—Si alloy material 16 can be defined as eutectic alloy material 16 for Si in the range of approximately 16% wt, hyper eutectic alloy material 16 for Si in the range of approximatley 16% wt to 99% wt, and hypo eutectic alloy material 16 for Si in the range of 1% wt to approximately 16% wt. As further described below, the Cu—Si alloy material 16 for use in the chlorination chamber 12 of the chlorination-deposition system 10 Si can be of a percent weight less than the eutectic point EP in the range such as but not limited to; 1-16%, 4-16%, 5-16%, 6-16%, 7-16%, 8-16%, 9-16%, 10-16%, 11-16%, 12-16%, 13-16%, 14-16%, 1-15%; 4-15%, 5-15%, 6-15%, 7-15%, 8-15%, 9-15%, 10-15%, 11-15%, 12-15%, 13-15%, 14-15%, to restrict or to otherwise inhibit the formation of the silicon crystallites 120 (i.e. free silicon) as silicon in the alloy material 16 that is outside of the matrix/lattice 114. It is recognised that the crystallites 120 can be considered precipitates formed outside of the Cu—Si matrix 114 (i.e. the excess silicon—greater than approximately 16% wt—is insoluble in the Cu—Si matrix 114 and therefore forms the crystallites 120 outside of the matrix 114)

For example, it is recognized that for hypo-eutectic alloy material 16 at about 12% wt silicon, there is effectively little to no free silicon (i.e. crystallites 120) in the alloy material 16. As the % wt of the silicon approaches that of the eutectic point EP (e.g. approximately 16% wt), there can be up to 4% wt native silicon that is composed in atomic strings contributing to a homogeneous alloy mixture (i.e. the native silicon is dispersed in the eutectic structure 114, such that the alloy mixture can be considered a single phase homogeneous mixture). As one exceeds the % wt of the silicon for the eutectic point EP (e.g. approximately 16% wt), excess silicon solidifies as pure silicon crystallites 20 dispersed as one phase of a multi-phase heterogeneous mixture (i.e. comprising the eutectic material 114 and the silicon crystallites 120). Accordingly, the alloy material 16 having % wt of the silicon less the % wt silicon for the eutectic point EP (e.g. approximately 16% wt) can be considered a single phase alloy material 16.

In terms or homogeneous versus heterogeneous , a homogeneous mixture has one phase although the solute A and solvent B can vary. Mixtures, in the broader sense, are two or more substances physically in the same place, but not chemically combined, and therefore ratios are not necessarily considered. A heterogeneous mixture can be defined as a mixture of two or more mechanically dividable constituents.

Let's consider, for example, two pure copper -based alloy materials 16, the first alloy material 16 with a hypo eutectic silicon content of 7%, the second with a hyper eutectic silicon content of 22%. The cooling speed of the alloy liquid is assumed to be low to allow an equilibrium to be established between the phases by short-time diffusion during solidification. The structure of the hypoeutectic alloy material 16 is comprised of the network of fine eutectic Si dispersed in the pure copper matrix 114. On the contrary, after the hypereutectic alloy material 16 has cooled, the material structure consists of primary silicon crystals 120 dispersed as a different phase to that of the eutectic phase as the matrix 114 that comprises pure copper and eutectic Si.

Further, it is recognised that for copper containing alloy material 16, the presence of copper combined atomically with silicon or other elements (e.g. bonded with silicon in the matrix 114) at the external surface of the alloy material 16 provides for facilitating the reaction of the silicon with the input gas 13 to generate the transport gas 15 (e.g. the presence of atomically bonded copper acts as a catalyst for the reaction between silicon and the input gas 13). Further, it is recognised that since the copper is in the matrix 114, rather than in free form (e.g. pure copper), the inclusion of copper in the transport gas 15 as an impurity can be inhibited.

Advantages for Alloy Material 16 Other than Hyper Eutectic

It is recognized that alloy material 16 described as hyper eutectic refers to the presence of multi-phase alloy having the eutectic material phase 114 and the silicon crystallites 120 (e.g. Si crystallites 120).

Referring to FIGS. 7A,B, as described earlier, in the case of hyper-eutectic alloy materials 16, larger grain-sized silicon crystallites 120 are interspersed throughout the eutectic matrix 114 component/phase of the alloy material 16. This heterogeneous multi-phase alloy mixture has significant consequences for the further use and behaviour of the alloy material 16 both inside and outside of the chlorination-deposition system 10. For example, during the casting process of the alloy material 16, e.g. making of the alloy material 16 for subsequent use in the system 10, first the silicon crystallites 120 are formed and they are embedded in the matrix 114 of eutectic metal-silicon. The silicon crystallites 120 have a different thermal expansion coefficient compared to the matrix 114 of eutectic metal-silicon, which can result in the formation of cracks and micro-cracks 122 in the matrix 114 of eutectic metal-silicon during the cooling down of the alloy material 16 from the eutectic solidification point (e.g. Tm=800 C for Cu—Si) to room temperature during the casting process. These micro-cracks 122 can result in an ongoing oxidation of the cast alloy material 16, as long as it is not stored in inert atmosphere for example. Under normal atmosphere, the shelf-time of the alloy material 16 can be limited and can result in decomposition and disintegration of the cast pieces of the alloy material 16 after a certain period of time.

Further, the elevated oxygen levels in the hyper-eutectic alloy material 16 due to the continuous oxidation can result in increased oxygen concentrations in the deposited high purity silicon 27 (obtained from the alloy material 16 during the chlorination-deposition process 8. Further, during the exposure to the input gas 13 under normal operational temperatures in the chlorination region 12 of the chlorination process 9, the hyper-eutectic metal-silicon material 16 can swell (e.g. expand due to thermal expansion and/or penetration of the input gas 13 into the alloy material 16 via the cracks 122) and it has been found that the volume of the alloy material 16 can increase by approximately a factor of 2. Further, the expansion of the alloy material 16 can form smaller pieces 124,126 such that the physical form of the alloy material 16 can degenerate into a spongy, rather unstable material form, which can easily fall apart (i.e. powder) upon repeated exposure to the chlorination process gas 13 and associated chlorination temperatures T of the chlorination process 9. The swelling/decomposing of the hyper-eutectic alloy material 16 can also lead to the formation of dust and particles 124 in the chlorination-deposition system 10, which may be transported by the gas stream 15 and can affect the purity of the refined silicon 27. In the worst case, the particle 124 can be incorporated into the deposited silicon 27 itself. A further disadvantage of using hyper-eutectic alloy material 16 is that the depleted alloy material 16 can oxidize easily due to its spongy, rather powdery structure and therefore can be difficult to collect for re-melt/re-use.

For example, in terms of the alloy material 16 embodied as Cu—Si alloy material 16, the structure of the eutectic or hypo-eutectic copper-silicon material 16 is distinguished from hyper-eutectic alloys in such a way that the eutectic or hypo-eutectic copper-silicon material 16 inhibits cracks 122 formation during the cooling of the casting process, which can inhibit the absorption of oxygen and/or moisture once the formed eutectic or hypo-eutectic copper-silicon material 16 is exposed to air or other environmental conditions in which oxidants and/or moisture have access to the eutectic or hypo-eutectic copper-silicon material 16. This crack 122 inhibition can enhance the shelf-time of cast material 16 and further on, can reduce the amount of oxygen or other impurities for the process 8, which might be trapped in any cracks 22 in the case of hyper-eutectic alloys and released during the chlorination process 9.

For eutectic or hypo-eutectic copper-silicon alloy material 16, the lack of embedded silicon crystallites 120 (as formed in the case of hyper-eutectic alloys material) has some major consequences for the use in the chlorination reactor process 9. If silicon is extracted from crystallites 120 in hyper-eutectic alloy material 16 during the process 9, large voids or cavities 122 (i.e. expanded cracks 122) can be formed and the process gas 13 can penetrate into the bulk of the alloy material 16. This can result in a swelling/expansion of the alloy material 16 which can lead to a partial/complete disintegration or powdering of the alloy material 16. This disintegration can lower the filter effect of the alloy material 16, further described below, for holding back undesired impurities and thus can make the purification process 8 less efficient of the chlorination-deposition process.

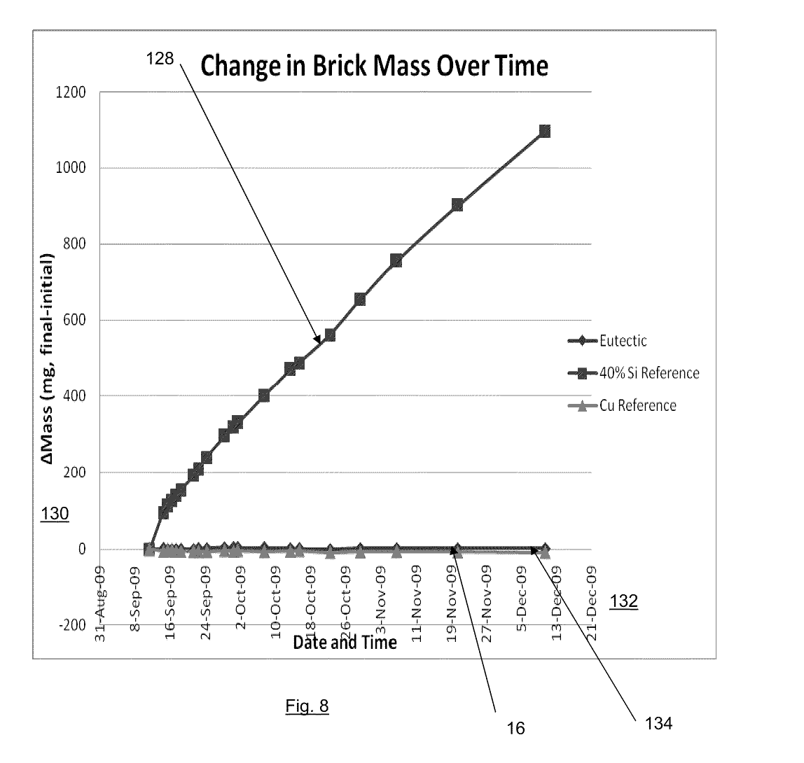

Referring to FIG. 8, oxidation behavior of eutectic copper-silicon alloy material 16 (approximately 16% wt silicon) versus oxidation behavior of hyper-eutectic alloy material 128 (40% wt silicon). Two pieces of similar shape (8×8×1.5 cm) alloy material 16,128 were stored under normal lab atmosphere and the material weight 130 was measured as a function of time 132. A piece of plain copper 134 was used as reference sample. The hyper-eutectic alloy 128 showed a continuous weight-gain, indicating ongoing oxidation. Within approximately 3 months, a weight gain of more than 1 g was measured, which was about 0.2% of the original total weight of the alloy material 128 (it was noted that after about 6 to 12 months, hyper-eutectic pieces 128 normally decomposed and fall apart). At the same time, the eutectic copper-silicon piece 16 did not show any significant weight gain, which may be explained by the solid, crack-free structure of the eutectic material 16.

### Forming of Alloy Material 16

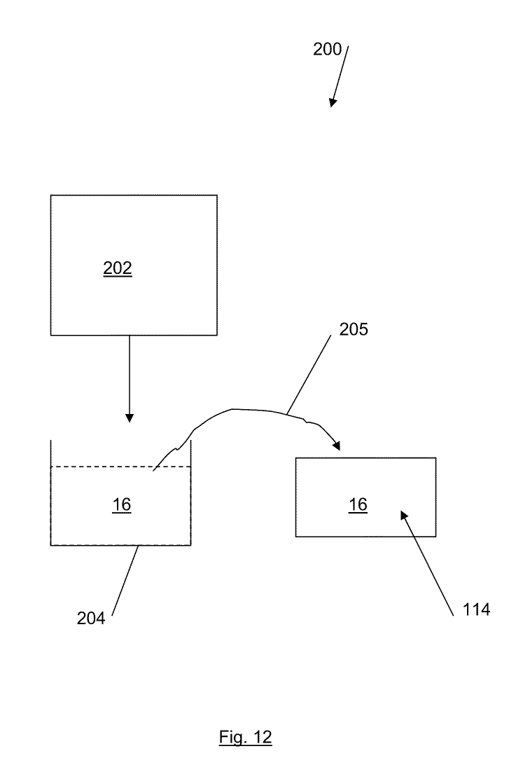

Referring to FIG. 12, shown is an example casting apparatus 200 used for a manufacturing process of the alloy material 16 by which a liquid material 202 containing measured percentage amounts of metal and silicon that are combined and then poured into a mold 204, which provides a hollow cavity of the desired physical shape of the alloy material 16. The molten liquid material 202 is then allowed to solidify at a controlled temperature to provide for the desired eutectic or hypo eutectic matrix 114 (see FIGS. 7A,B/9A,B) of the alloy material 16. Further, the cooling process is controlled to maximize the integral matrix 114 properties of the alloy material 16 (e.g. which can be characterized as a multi crystalline structure) as well as to minimize any formation of crystallites 120 (see FIG. 7A). The solidified alloy material 16 is also known as a casting, which is ejected 205 or broken out of the mold 204 to complete the process.

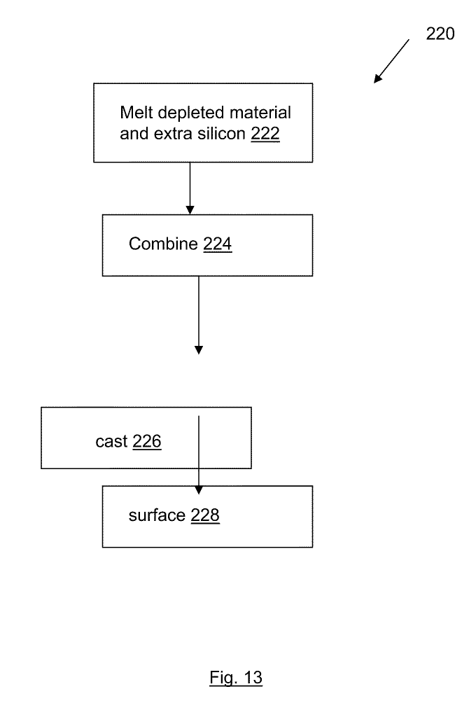

Referring also to FIG. 13, in accordance with the preferred embodiment, the eutectic or hypo-eutectic metal-silicon alloy material 16 is produced by a casting process 220, which can also be modified to be used as a recasting process for the silicon depleted alloy material 16. In this process, silicon, as for example m.g.-silicon, is melted 202 together with metal (e.g. copper) or with a hypo-eutectic silicon-copper mixture (e.g. depleted alloy material 16). The melting can be carried out in a graphite crucible or any crucible material, which withstands a silicon-copper melt 202 and does not unduly introduce additional impurities into the melt. Subsequently, the melt 202 is poured into the moulds 204, preferably, but not exclusively, graphite moulds 204, in order to form the desired eutectic or hypo-eutectic alloy material 16 of defined shape and geometry (e.g. by the shape of the mould 204). In contrast to metal-silicon alloys of higher silicon concentration, e.g. hyper eutectic composition, the eutectic or hypo-eutectic material 16 can be cast in a variety of different shapes (bricks, slabs, thin plates) since the material can be cooled stress-free. For example, the cooling process of the casting is configured to minimize/inhibit gas porosity, shrinkage defects, mould material defects, pouring metal defects, and/or metallurgical/matrix 114 defects. It is also recognised that the physical form/shape of the alloy material 16 can be configured for fixed bed or fluidized bed reactors (e.g. regions 12) of the apparatus 10.

Accordingly, the alloy material 16 can be cast to take any desired physical form, for example bricks, plates, granules, chunks, pebbles or any other shape, which allows an easy charging of the chemical vapour region 12 and which preferably provides a selected surface 136 to volume ratio above a defined ratio threshold.

Further, the cast eutectic or hypo-eutectic pieces 16 might be subject to a surface treatment before using it for the vapour gas production or they might be used directly. Possible surface treatments include e.g. sand-blasting or chemical etching, in order to remove any surface contamination or any oxide skin, as it might form during the casting process.

For example, the eutectic or hypo-eutectic bricks, slabs or plates (or whatever shape is required) can be used as source material 16 for the production of chlorosilanes in a chlorination reactor 12.

### Recasting of the Alloy Material 16

Referring to FIG. 13, shown is the recasting process 220 (for producing metal silicon alloy material 16 having a selected percent weight of silicon at or below the eutectic weight percent of silicon defined for the respective metal silicon alloy) performed after the anticipated amount of silicon is extracted from the eutectic or hypo-eutectic material 16 in the process 9 (see FIG. 1). The depleted slabs, bricks or plates or other physical form of the alloy material 16 can be removed from the chlorination region 12 since the alloy material 16 can retain its structural integrity due to the inhibition of cracking 122 due to the substantial absence (e.g. lack) of crystallites 120 present in the alloy material 16 for hypo eutectic and/or eutectic materials 16. Depending on the required purity level in the produced chlorosilane stream 13 or the deposited poly-silicon 27, respectively, the depleted material 16 may be re-melted and mixed with additional silicon in order to form fresh eutectic or hypo-eutectic material 16 for further use in the chlorination process 9. The number of recycles of the depleted material 16 can depend on threshold values for individual impurities and the impurity levels of the used mg.-silicon.

At step 222, melting the depleted metal silicon alloy material 16 is done such that the depleted metal silicon alloy material 16 has a concentration of silicon in the atomic matrix 114 increasing away from the exterior surface 136 of the metal silicon alloy material 16 towards the interior 140 of the metal silicon alloy material 16, such that the percent weight of the silicon adjacent to the exterior surface 136 in the depleted material is at or below the hypo eutectic weight percent of silicon range defined for the respective metal silicon alloy. At step 224, silicon is added (e.g. as metallurgical grade silicon) to the depleted metal silicon alloy material 16 (either melted, solid, or in partially melted form, for example) for enhancing the percent weight content of silicon of the resultant melt material to a selected percent weight of silicon at or below the eutectic weight percent of silicon defined for the respective metal silicon alloy. At step 226 the molten alloy material is cast to produce solid metal silicon alloy material 16 suitable for redeployment to the chemical vapour generation region of the apparatus 10 (see FIG. 1). An optional step 228 is surface treat the cast metal silicon alloy material 16.

It is recognised that surface treatment can be done with hypo-eutectic alloy (e.g. washing off metal-chlorides which have been accumulated on the surface. With hyper-eutectic, this may not possible due to the spongy structure, i.e. crack 122 formation, as discussed. Weather surface treatment can be done or not depending on the threshold value for the impurities contained in the alloy material 16 as a result of the casting process. Further, during casting, slagging-off of oxides and/or carbides could be done as a surface treatment of the alloy material 16.

### Filter Effect of Alloy Material 12

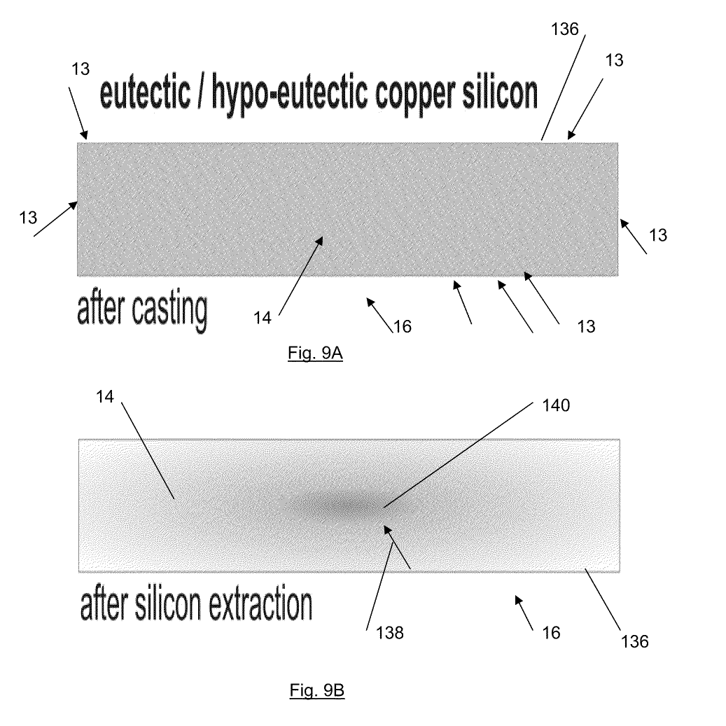

Referring to FIGS. 1, 9A, 9B, it is recognized in the case of hyper eutectic alloy material 16 (i.e. containing crystallites 120—see FIG. 7A), the swelling of the material 16 might influence or block the gas 13 flow and the release of powder and particles from the disintegration of the alloy material 16 (due to expansion/cracking) may introduce impurities/contaminates into the transport gas 15 that could contaminate the deposited silicon 27.

In the case of eutectic or hypo-eutectic copper-silicon (i.e. substantially absent the crystallites 120—see FIG. 7A), the alloy material 16 pieces do not swell or change their shape appreciably, thereby discouraging the formation/propagation of cracks 122 and resultant disintegration and/or destruction of the physical integrity of the alloy material 16. Accordingly, reaction with the input/process gas 13 takes place on the surface 136 of the hypo eutectic or eutectic material 16. Since silicon is known to have a significantly faster diffusion rate in copper-silicon than other metal elements, an efficient filter effect can be achieved for any impurities resident in the alloy material 16, as only those elements(i.e. Si or any other considered impurity elements in the alloy material 16), which have diffused to the surface 136 can react with the process gas 13.

Accordingly, the matrix 114 can be regarded as a filter or getter of impurities in the alloy material 16 (for example also in the matrix 114 with the copper and silicon), since the temperature and other operating parameters for the transport gas generation 9 provides for diffusion of the silicon in the matrix to be preferred (i.e. greater in magnitude) than diffusion of the considered impurity atoms (e.g. Cr, Fe, O2, N2, boron, phosphorous, etc.) through the alloy material 16. Therefore, the matrix 114 acts as a getter/filter during the chemical/metallurgical process of silicon reaction with the input gas 13 to absorb impurities that would otherwise get into the transport gas 15. It is also recognized that the diffusion/transfer rate of the silicon in the alloy matrix 114 is dependent upon a number of parameters including process 9 temperature and/or concentration gradient of Si in the matrix 114 (e.g. the concentration of Si in the matrix 114 will first deplete near the surface of the alloy material 16 upon reaction with the input gas 13, thus setting up a concentration gradient for silicon in the matrix 114 between the external surface and interior of the alloy material 16).

Atomic diffusion is a diffusion process whereby the random thermally-activated movement of atoms in a solid material 16 results in the net transport of atoms. The rate of transport is governed by the diffusivity and the concentration gradient 138. In the crystal solid state of the matrix 114, diffusion of the Si within the crystal lattice 114 occurs by either interstitial and/or substitutional mechanisms and is referred to as lattice diffusion. In interstitial lattice diffusion, a diffusant (such as Si in an Metal-Si alloy), will diffuse in between the lattice structure of another crystalline element. In substitutional lattice diffusion (self-diffusion for example), the Si atom can move by substituting place with another atom in the matrix 114. Substitutional lattice diffusion is often contingent upon the availability of point vacancies throughout the crystal lattice 114. Diffusing Si atoms migrate from point vacancy to point vacancy in the matrix 114 by the rapid, essentially random jumping about (jump diffusion).

Since the prevalence of point vacancies increases in accordance with the Arrhenius equation, the rate of crystal solid state diffusion can increase with temperature. For a single atom in a defect-free crystal matrix 114, the movement of the Si atom can be described by the “random walk” model. In 3-dimensions it can be shown that after n jumps of length a the atom will have moved, on average, a predefined distance. Atomic diffusion of Si in polycrystalline matrix 114 materials 16 can involve short circuit diffusion mechanisms. For example, along the grain boundaries and certain crystalline 114 defects such as dislocations there is more open space, thereby allowing for a lower activation energy for diffusion of the Si element. Atomic diffusion in polycrystalline 114 materials 16 is therefore often modeled using an effective diffusion coefficient, which is a combination of lattice, and grain boundary diffusion coefficients. In general, surface diffusion occurs much faster than grain boundary diffusion, and grain boundary diffusion occurs much faster than lattice diffusion.

Therefore, since silicon is known to have a significantly faster diffusion rate in metal-silicon than other impurity elements (those elements not desired for introduction/inclusion in the transport gas 15), the slower moving impurity elements are trapped in the bulk material 16, as the silicon in the matrix 14 is preferentially diffused to the surface 136 for reaction. In contrast to alloy with excess of silicon (i.e. crystallites 120), only Kirkendall-voids are predominantly formed in the matrix 114 upon depletion of the silicon element from the matrix 114, rather than larger cavities (e.g. cracks 122). The reaction of surface silicon with the process gas 13 creates a concentration gradient 138 and thus drives the silicon diffusion in direction to the surface 136. Since the amount of available silicon on the surface 136 is defined by the velocity of the solid-state diffusion, the temperature T during the chlorination process 9 is chosen appropriately, such that if the process 9 temperature is too low, the replenishment on the surface 136 with fresh silicon is too low. If the temperature is too high, impurities might migrate through the matrix 114 along with the silicon in sufficient quantities to be undesirably included in the transport gas 15 at concentrations above a defined impurity threshold. In principle, the process 9 can be operated at any temperature between 200C and the melting point of the alloy material 16 (e.g. approximately 800C marking the melting point Tmp of the eutectic alloy material 16 for Cu—Si alloy). For example, 200C can be an example of a lower temperature boundary where diffusion of the silicon becomes below a defined minimum diffusion threshold.

In the case of desired metal silicon alloy materials 16 (e.g. Cu—Si), the approximately eutectic or hypo-eutectic alloy material 16 is heated by the heating means 6 to between a selected temperature range (e.g. 250C-550C, 300C-500C, 350C-450C, 375C-425C, 250C-350C, 350C-550C, 250C-300C, 400C-500C, 400C-550C) for the formation of trichlorosilane or other gas 13 and heated to higher temperatures (e.g. 450C-Tmp, 500C-Tmp, 550C-tmp, 600C-Tmp, 650C-Tmp, 700C-Tmp, 750C-Tmp, 800C-Tmp) if silicon tetrachloride or other gas 13 is preferred. Pressures of the process 9 can be in the range of 1-6 bars, for example. Further, it is recognized that the temperature and pressure process parameters could be adjusted in other metal silicon alloy material 16 (other than Cu—Si) configurations to facilitate/maximize the diffusion of the silicon through the matrix 114.

### Properties of Deposited Silicon 27

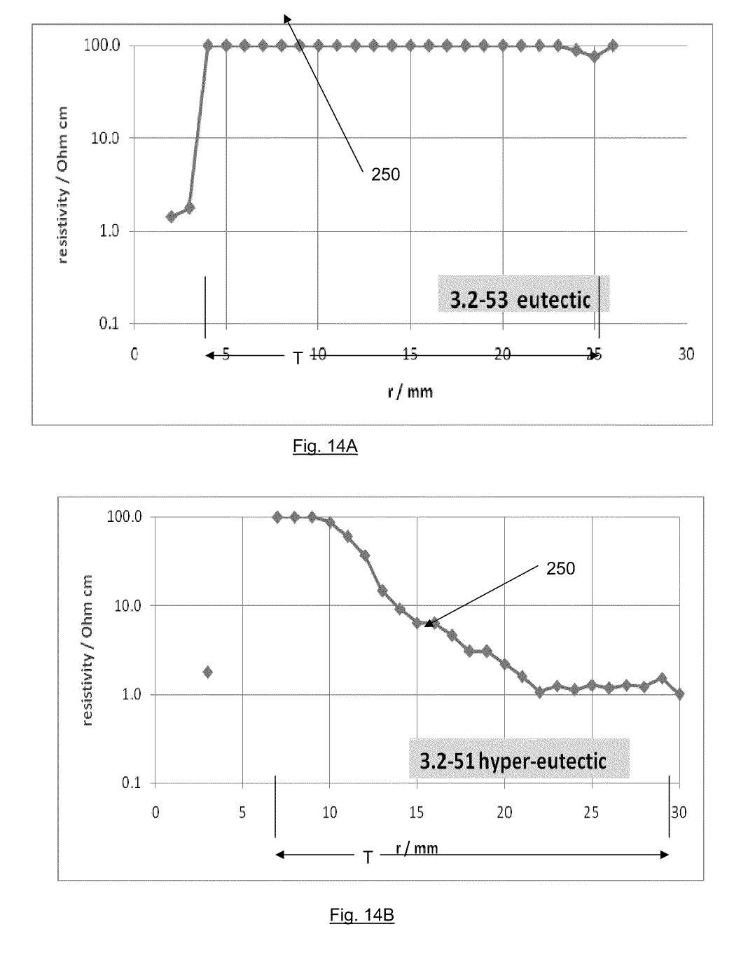

Referring to FIGS. 14A,B: resistivity of purified silicon 27 using eutectic copper-silicon as source material (12a) and using hyper-eutectic alloy (silicon concentration 30%, 12b). The silicon 27 was deposited on hot filaments 26 by decomposing chlorosilane (i.e. trichlorosilane) produced in the chlorination region 12 by using the hyper-eutectic or the eutectic copper-silicon alloy material 16, respectively. After deposition, the poly-silicon rods 27 were cut into slices and the radial resistivity profile 250 was measured by a 4 point probe. (N.b. resistivity values larger 50/100 Ohm cm are set to 50/100 Ohm cm, since this marks roughly the range up to where bulk resistivity still can be measured; above 50/100 Ohm cm, influence of surface condition and grain boundaries becomes significant.) The eutectic copper-silicon shows a significantly better filter effect/getter effect than the hyper-eutectic one, as the resistivity value 250 remains substantially constant throughout the deposited silicon 27 thickness T. On the average, the material deposited from eutectic material shows a resistivity about one order of magnitude higher in selected thickness T locations of the material slice as compared to the resistivity of the silicon 27 deposited from hyper-eutectic material. (Note: the first 3-4 mm of the radius are not deposited silicon but the initial filament.). Accordingly, it is recognized that the resistivity of the deposited silicon 27 is maintained above a selected minimum resistivity threshold throughout a thickess of the deposited silicon 27 due at least in part to the filtering affect of the matrix 114 during the process 9.

### Example Operation of the Apparatus 10

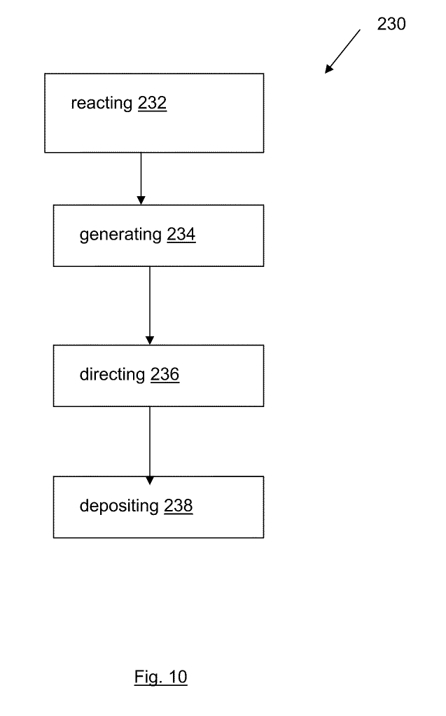

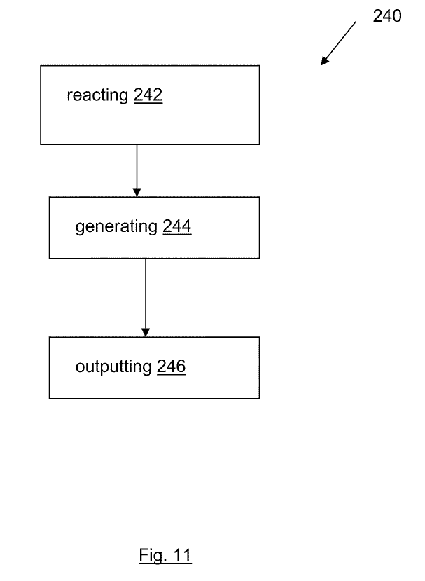

Referring to FIGS. 1, 10, shown is an example method 230 for using the apparatus 10 (see FIG. 1) for purifying silicon comprising the steps of: reacting 232 an input gas 13 with a metal silicon alloy material 16 having a silicon percent weight at or below the eutectic weight percent of silicon defined for the respective metal silicon alloy; generating 234 a chemical vapour transport gas 15 including silicon obtained from the atomic matrix 114 of the metal silicon alloy material 16; directing 236 the vapour transport gas 15 to a filament 16 configured to facilitate silicon deposition; and depositing of the silicon 27 from the chemical vapour transport gas 15 onto the filament 26 in purified form.

Referring to FIGS. 1, 10, shown is an example method 240 for producing chemical vapour transport gas 15 for use in silicon purification through silicon deposition 11 comprising the steps of: reacting 242 an input gas 13 with a metal silicon alloy material 16 having a silicon percent weight at or below the eutectic weight percent of silicon defined for the respective metal silicon alloy; generating 244 the chemical vapour transport gas 15 including silicon obtained from the atomic matrix 114 of the metal silicon alloy material 16; and outputting 246 the vapour transport gas 15 for use in subsequent silicon deposition 11.

### Example Result of Alloy Material 16 Before and After Processing 8

Referring to FIGS. 9A,B, shown is a schematic microstructure of a eutectic copper-silicon piece 16 before and after being subjected to the vapour generation process 9 (see FIG. 1). In FIG. 9A, after casting, the eutectic copper-silicon alloy material 16 is of uniform composition (e.g. single phase with a homogeneous distribution of the silicon in the copper matrix 14). In FIG. 0B, after extraction of silicon in the chlorination region 12: the eutectic (or similar in case of hypo-eutectic composition) is still intact and the alloy material 16 does not change appreciable its original shape that was inserted into the region 12. During extraction of silicon from the alloy material 16, in FIG. 9A, silicon diffuses to the surface 136 of the alloy material 16 through the matrix 14, where it reacts with the input gas 13. Once substantially depleted of silicon with respect to the requirements of the vapour generation process 9, the alloy material 16 contains a gradient 138 of silicon remaining resident in the matrix 14, such that the concentration of silicon in the matrix increases away from the exterior surface of the alloy material 16 towards the interior 140 (e.g. central region) of the alloy material 14.

It is recognized that the presence of any silicon crystallites 120 (see FIG. 7A) in the interior 140 of alloy material 16 would have to diffuse through the alloy material 16 to reach the surface 136 for subsequent interaction with the input gas 13. Accordingly, it is recognized that the rate of diffusion (e.g. matrix diffusion) of Si originally resident in the matrix 14 to the surface 136 and subsequent interaction with the input gases 13 would be different than the rate of diffusion (e.g. material diffusion) of Si not originally resident in the matrix 14 (e.g. in the crystallites 120—see FIG. 7A) to the surface 136 and subsequent interaction with the input gases 13. In certain cases, it is recognized that desired interaction between the Si in the crystallites 120 may preferentially occur via disintegration of the alloy material 16 via the above-described expansion/cracking and therefore not necessarily via diffusion through the alloy material 16 (i.e. cracking would expose the embedded crystallites 120 to the input gas 13.

### EXAMPLES

The following examples illustrate the properties and the behaviour of the eutectic and hypo-eutectic copper-silicon alloy materials 16 for the use in chlorosilane gas 13 production 9 and subsequent production 11 of high purity silicon 27. These are examples only and are not meant to be limiting in any way, in particular to the different metals that can be used in the metal silicon alloy materials 16 in keeping with the spirit of the described metal silicon hypo eutectic and eutectic alloy materials 16 having a defined absence of excess silicon outside of the metal silicon matrix 114 (e.g. as precipitated crystallites 120).

### Example 1

A slab of eutectic copper-silicon (8×8×1.5 cm) was cast, the weight was measured and it was exposed to atmosphere (normal lab atmosphere). For comparison, a hyper-eutectic slab with a silicon concentration of 40% wt silicon and similar dimensions was cast and handled the same way as the eutectic one. For reference, a pure copper plate was used. The weight of the 3 different pieces was measured over a period of three months (see FIG. 8). Whereas the hyper-eutectic alloy slab showed a continuous increase of weight over time (after three months, the weight had increased by more than 1 gram, the initial weight of the piece was approx. 400 g), no significant change was detected for the eutectic copper-silicon. This indicates that the hyper-eutectic alloy absorbs oxygen and/or moisture in continuous manner, the amount of gained weight implies that a continuous oxidation goes on. Micrographs of cast hyper-eutectic alloy slabs show an intense net-work of micro-cracks, which provides a large surface for oxidation. Further, it can be assumed that the oxidation results in a volume change/expansion, which creates more cracks and thus facilitates further oxidation. Since the eutectic (as well as hypo-eutectic) material does not preferentially form micro-cracks during casting, oxidation can occur only on the slab 16 surface itself but does not penetrate into the bulk of the material 16.

### Example 2

Two slabs of eutectic and of hyper-eutectic (30% wt silicon) composition where exposed to normal atmosphere, no special treatment was applied. After a shelf-time of approximately 6 months, the hyper-eutectic slab lost its integrity and fell apart, the eutectic slab did not change and kept its solid structure appreciably.

### Example 3

Eutectic plates of 3 mm thickness and a length of 20×10 cm were cast in graphite moulds. The plates could be produced crack-free. For comparison, casting of hyper-eutectic plates (30% wt and 40% wt silicon) of similar geometry always resulted in sever cracking and breaking, caused at least in part by the stress due to the different thermal expansion coefficients of the eutectic matrix 114 and the interspersed silicon crystallites 120.

### Example 4

Eutectic slabs (bricks) of 8×8×1.5 cm size have been placed in a chlorination reactor (see application “Method and Apparatus for the Production of Chlorosilanes”). Total amount of eutectic-copper slabs was 40 kg, the temperature in the chlorination reactor during the reaction with the process gas was in the range of 300 to 400 C. The produced chlorosilanes were sent into a deposition reactor without further purification (see application “Method and Apparatus for Silicon Refinement”). Over a period of 90 hours, 4 kg of silicon had been extracted from the eutectic slabs and deposited on heated silicon filaments, placed in a separate deposition chamber. The average deposition rate was 44 g/h. After deposition, the radial resistivity profile of the deposited poly-silicon rods was measured using 4 point probe. Over the whole radius, the resistivity was in the range of 100 Ohm cm or higher, indicating a very efficient impurity gettering by the eutectic copper-silicon (see FIG. 14A). Over the whole chlorination process, the eutectic copper-silicon slabs did not appreciably change their physical shape and after the process, they were fully intact, such that they maintained their physical structural integrity.

For comparison, hyper-eutectic alloy of 40 wt % silicon was cast in a similar way and used in the same chlorination process 9 under similar conditions with respect to temperature and gas composition. The weight of the used hyper-eutectic alloy was 26 kg. The produced chlorosilanes were sent into a deposition process 11 without further purification. A total of 5.4 kg of silicon was deposited, the average deposition rate was 46 g/h. The corresponding resistivity profile over the radius of the deposited poly-silicon shows a significantly lower resistivity, especially towards the edge of the slice (FIG. 14B). This clearly indicates that the getter effect for electrically active impurities (i.e. boron, as confirmed by chemical analysis) is less for hyper-eutectic alloy compared to eutectic and/or hypo eutectic one. During the chlorination process, the hyper-eutectic slabs did swell and a large part of them did fell apart, forming an extensive amount of powder.

### Example 5

Hypo-eutectic slabs (eta-phase—12% wt silicon) had been cast and placed in a chlorination reactor. Temperature during chlorination was in the range of 270 to 450 C. 54 kg of hypo-eutectic copper-silicon was used. The produced chlorosilanes were sent into a deposition reactor without further purification. Within 117 hours, 4 kg of poly-silicon was deposited on heated filaments. The hypo-eutectic slabs did not change its shape, after extraction of silicon, slab integrity was fully given. No substantive powdering or swelling was detected.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments. Further, all of the claims are hereby incorporated by reference into the description of the preferred embodiments.

Any publications, patents and patent applications referred to herein are incorporated by reference in their entirety to the same extent as if each individual publication, patent or patent application was specifically and individually indicated to be incorporated by reference in its entirety.

1. A method for producing chemical vapour transport gas for use in silicon purification through silicon deposition, the method comprising:
reacting an input gas with a metal silicon alloy material having a silicon percent weight at or below the eutectic weight percent of silicon defined for the respective metal silicon alloy;
generating the chemical vapour transport gas including silicon obtained from the atomic matrix of the metal silicon alloy material; and
outputting the vapour transport gas for use in subsequent silicon deposition.

2. The method of claim 1, wherein the weight percent of silicon is a weight percent range.

3. The method of claim 2, wherein the weight percent range is approximately 8 to approximately 16 percent weight silicon for the metal silicon alloy using copper as the metal.

4. The method of claim 1, wherein the vapour transport gas includes chlorosilanes and the metal silicon alloy uses copper as the metal.

5. The method of claim 4, wherein the input gas comprises hydrogen chloride, hydrogen or a combination of hydrogen chloride and hydrogen.

6. The method of claim 5, wherein the copper silicon alloy is a metallurgical grade silicon.

7. The method of claim 2, wherein the metal of the metal silicon alloy is selected from the group consisting of: copper; nickel; iron; silver; platinum; palladium; and chromium.

8. The method of claim 3, wherein the copper silicon alloy comprises from about 1 to about 16 percent weight of silicon.

9. The method of claim 8, wherein the silicon-copper alloy comprises from about 10 to about 16 weight of silicon.

10. The method of claim 4, wherein the copper silicon alloy material is at a controlled alloy material temperature.

11. The method of claim 10, wherein the controlled alloy material temperature is between a minimum diffusion threshold temperature and a melting point temperature of the copper silicon alloy material.

12. The method of claim 10, wherein the controlled alloy material temperature is between a temperature of about 300° C. to about 500° C.

13. The method of claim 1 further comprising producing a silicon concentration gradient between an exterior surface of the metal silicon alloy material and an interior of the metal silicon alloy material for facilitating atomic diffusion of the silicon through the metal silicon matrix to the exterior surface for consumption by the input gas.

14. The method of claim 13, wherein the presence of silicon crystallites in the metal silicon alloy material is below a defined crystallite threshold.

15. The method of claim 14, wherein the defined crystallite threshold is a property of a hypo eutectic percent weight of silicon in the metal alloy.

16. The method of claim 14, wherein the defined crystallite threshold is a property of an eutectic percent weight of silicon in the metal alloy.

17. The method of claim 1 further comprising the metal silicon alloy material acting as a getter for defined impurity components present in the metal silicon alloy material.

18. The method of claim 17, wherein the filtering of the defined impurity components facilitates the production of the purified silicon having a resistivity that remains above a defined minimum resistivity threshold throughout the deposited silicon thickness.

19. The method of claim 18, wherein a resistivity is at or greater than one order of magnitude higher in selected thickness locations of the material slice for the deposited silicon as compared to the resistivity deposited silicon from hyper eutectic alloy material.

20. The method of claim 1, wherein the metal silicon alloy material has an affinity for oxidation below a defined affinity threshold to facilitate the material retaining its structural integrity due to exposure of the material to oxidants.

21. The method of claim 14, wherein the presence of silicon crystallites in the metal silicon alloy material below a defined crystallite threshold inhibits decreases in the structural integrity of metal silicon alloy material during exposure to the input gas.

22. An apparatus for producing chemical vapour transport gas for use in silicon purification through subsequent silicon deposition, the method comprising:
a chamber configured for reacting an input gas with a metal silicon alloy material having a silicon percent weight at or below the eutectic weight percent of silicon defined for the respective metal silicon alloy and for generating the chemical vapour transport gas including silicon obtained from the atomic matrix of the metal silicon alloy material; and
an output coupled to the chamber for outputting the vapour transport gas for use in subsequent silicon deposition.

23. A chemical vapour reactor containing a metal silicon alloy material having a silicon percent weight at or below the eutectic weight percent of silicon defined for the respective metal silicon alloy.

24. A chemical vapour reactor containing metal silicon alloy material having a silicon percent weight at a selected eutectic weight percent of silicon defined for the respective metal silicon alloy, such that the presence of silicon crystallites in the alloy material is at or below a defined maximum crystallite threshold.
